(19) United States
(12) Patent Application Publication
(10) Pub. No.: US 2026/0032359 A1
(43) Pub. Date: Jan. 29, 2026

(54) IMAGING DEVICE

(71) Applicant: Panasonic Intellectual Property Management Co., Ltd., Osaka (JP)

(72) Inventors: HIDEYUKI UTSUMI, Osaka (JP); SOGO OTA, Osaka (JP)

(21) Appl. No.: 19/349,197

(22) Filed: Oct. 3, 2025

Related U.S. Application Data
(63) Continuation of application No. PCT/JP2024/013632, filed on Apr. 2, 2024.

(30) Foreign Application Priority Data
Apr. 7, 2023 (JP) 2023-062647

(51) Int. Cl. H04N 25/77

(52) U.S. Cl. CPC H04N 25/77

(57) ABSTRACT

A first structural body includes a photoelectric converter, a first one of a first pair of wiring layers, and a first substrate. A second structural body includes a second one of the first pair of wiring layers and a second substrate. A first via extends through the first substrate and directly connects the first pair of wiring layers. A charge storage region is provided on one of substrates including the first substrate and the second substrate. The charge storage region is electrically connected to the first via and stores electric charge. The first one of the first pair of wiring layers, the first substrate, the second one of the first pair of wiring layers, and the second substrate are arranged in that order.

### BACKGROUND

### 1. Technical Field

The present disclosure relates to an imaging device.

### 2. Description of the Related Art

Imaging devices are included in, for example, digital still cameras and digital video cameras. Examples of known imaging devices include amplification-type imaging devices exemplified by metal-oxide-semiconductor (MOS) image sensors, such as complementary metal-oxide-semiconductor (CMOS) image sensors, and charge-transfer-type imaging devices exemplified by charge-coupled device (CCD) image sensors. In recent years, imaging devices mounted in mobile devices, such as mobile phones equipped with cameras and smart phones, in particular, have been installed in limited spaces, and smaller imaging devices have been desired.

The size of an imaging device may be reduced by integration in a height direction in addition to planar directions of the imaging device.

Japanese Unexamined Patent Application Publication (Translation of PCT Application) No. 2008-536330 describes a separation type unit pixel having a 3D structure for an image sensor, the pixel including transistors provided on multiple wafers.

### SUMMARY

A technique suitable for providing a small, low-noise imaging device is desired.

In one general aspect, the techniques disclosed here feature an imaging device including at least one pixel, each of the at least one pixel including a first structural body including a photoelectric converter that converts light into electric charge, a first one of a first pair of wiring layers, and a first substrate; a second structural body including a second one of the first pair of wiring layers and a second substrate; a first via that extends through the first substrate and directly connects the first pair of wiring layers; and a charge storage region provided on one of substrates including the first substrate and the second substrate, the charge storage region storing the electric charge and being electrically connected to the first via. The first one of the first pair of wiring layers, the first substrate, the second one of the first pair of wiring layers, and the second substrate are arranged in that order.

The technique according to the present disclosure is suitable for providing a small, low-noise imaging device.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1A is a circuit diagram of an imaging device according to a first embodiment;

FIG. 1B is a sectional view of the imaging device according to the first embodiment;

FIG. 1C is a sectional view of a structure including a first substrate;

FIG. 2 is a sectional view of an imaging device according to a first reference example;

FIG. 3 is a sectional view of an imaging device according to a second reference example;

FIG. 4A is a circuit diagram of an imaging device having transistor arrangement (6) in Table 1;

FIG. 4B is a sectional view of the imaging device having transistor arrangement (6) in Table 1;

FIG. 5 is a circuit diagram of an imaging device having transistor arrangement (4) in Table 1;

FIG. 6A illustrates a method for manufacturing the imaging device according to the first embodiment;

FIG. 6B illustrates the method for manufacturing the imaging device according to the first embodiment;

FIG. 6C illustrates the method for manufacturing the imaging device according to the first embodiment;

FIG. 6D illustrates the method for manufacturing the imaging device according to the first embodiment;

FIG. 6E illustrates the method for manufacturing the imaging device according to the first embodiment;

FIG. 7 is a flowchart of the method for manufacturing the imaging device according to the first embodiment;

FIG. 8A is a circuit diagram of an imaging device according to a second embodiment;

FIG. 8B is a sectional view of the imaging device according to the second embodiment;

FIG. 9A is a circuit diagram of an imaging device according to a third embodiment;

FIG. 9B is a sectional view of the imaging device according to the third embodiment;

FIG. 10A is a circuit diagram of an imaging device according to a fourth embodiment;

FIG. 10B is a sectional view of the imaging device according to the fourth embodiment;

FIG. 10C is a sectional view of a structure including a second substrate;

FIG. 11 is a circuit diagram of an imaging device having transistor arrangement (11) in Table 3B;

FIG. 12 is a circuit diagram of an imaging device having transistor arrangement (12) in Table 3B;

FIG. 13 is a circuit diagram of an imaging device having transistor arrangement (19) in Table 3D;

FIG. 14 is a circuit diagram of an imaging device having transistor arrangement (23) in Table 3D;

FIG. 15 is a circuit diagram of an imaging device having transistor arrangement (24) in Table 3D;

FIG. 16 is a circuit diagram of an imaging device having transistor arrangement (35) in Table 3F;

FIG. 17 is a circuit diagram of an imaging device having transistor arrangement (36) in Table 3F;

FIG. 18A is a circuit diagram of an imaging device according to a fifth embodiment;

FIG. 18B is a sectional view of the imaging device according to the fifth embodiment;

FIG. 18C is a sectional view of a structure including a third substrate;

FIG. 19 is a circuit diagram of an imaging device having transistor arrangement (7) in Table 4B;

FIG. 20A is a circuit diagram of an imaging device according to a sixth embodiment;

FIG. 20B is a sectional view of the imaging device according to the sixth embodiment; and

FIG. 21 is a schematic diagram illustrating an example of the structure of a camera system according to an embodiment.

### DETAILED DESCRIPTIONS

Embodiments of the present disclosure will now be described in detail with reference to the drawings. Numerical values, shapes, materials, components, locations of the components, connections between the components, steps, the order of steps, etc., described in the embodiments are examples, and are not intended to limit the present disclosure.

In the embodiments, the terms “up”, “down”, and the like are used to designate the relative arrangement between members, and are not intended to limit the position of the imaging device in use or limit the positions of members of the imaging device and a manufacturing device while the imaging device is being manufactured.

In the embodiments, the term “via” refers to a wiring line that provides connection between wiring layers. A via includes a conductor provided in a hole. The term “trench” refers to a groove. A “substrate” may also be referred to as a “wafer”.

In the embodiments, the terms “connect” and “electrically connect” may be read interchangeably as long as there are no contradictions.

### First Embodiment

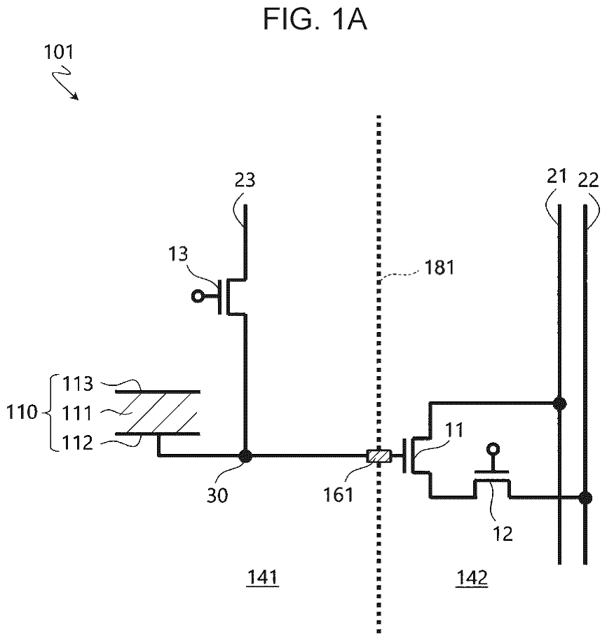

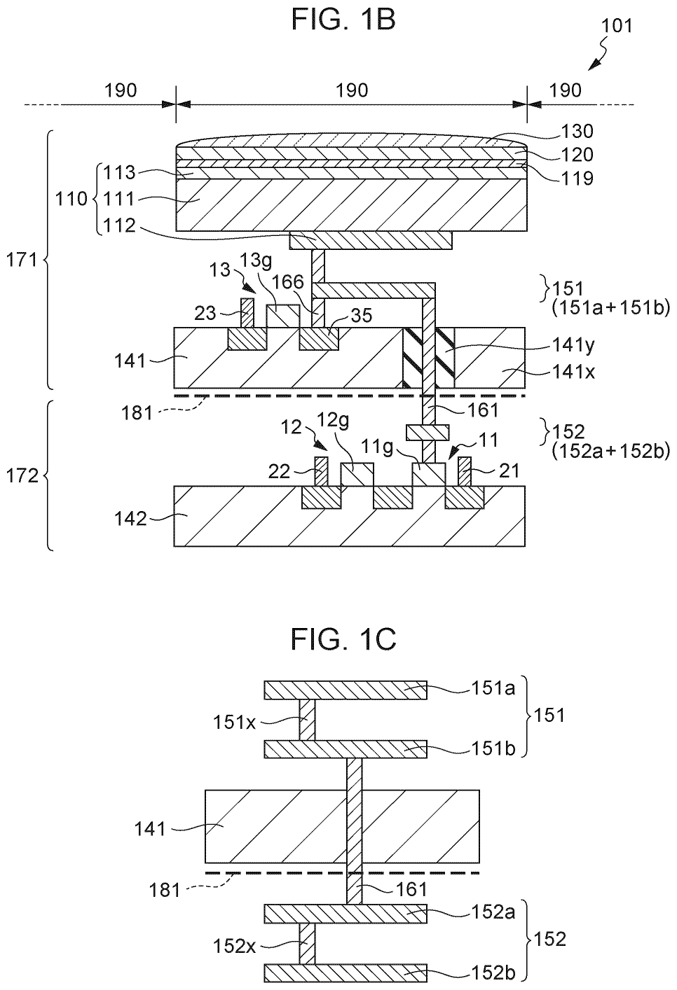

FIGS. 1A and 1B are a circuit diagram and a sectional view, respectively, of an imaging device 101 according to a first embodiment. The imaging device 101 is a front side illumination (FSI) imaging device. The imaging device 101 includes a photoelectric converter 110, a protective film 119, a color filter 120, a microlens 130, a reset transistor 13, an amplification transistor 11, a selection transistor 12, a first substrate 141, a second substrate 142, first wiring layers 151, second wiring layers 152, a first via 161, and a via 166. These elements are included in a pixel 190 of the imaging device 101. In a typical example, these elements are included in each of multiple pixels 190 of the imaging device 101. In FIG. 1B, the first wiring layers 151 and the second wiring layers 152 are simplified.

As illustrated in FIG. 1A, the imaging device 101 includes a charge storage node 30. The charge storage node 30 stores electric charge. The charge storage node 30 includes a charge storage region 35 illustrated in FIG. 1B.

The photoelectric converter 110 includes a photoelectric conversion film 111, a pixel electrode 112, and a counter electrode 113. The photoelectric conversion film 111 is disposed between the pixel electrode 112 and the counter electrode 113. The photoelectric conversion film 111 is positioned outside the first substrate 141. In the present embodiment, the photoelectric conversion film 111 includes an organic material. The photoelectric conversion film 111 may also include an inorganic material.

The microlens 130 has a function of focusing light on the photoelectric converter 110. The color filter 120 performs color separation. The protective film 119 protects the photoelectric converter 110.

As illustrated in FIG. 1A, the photoelectric converter 110 is electrically connected to one of a source and a drain of the reset transistor 13 and a gate 11g of the amplification transistor 11. More specifically, the pixel electrode 112 is electrically connected to these elements. The one of the source and the drain of the reset transistor 13 forms the charge storage region 35. In other words, the charge storage region 35 is included in the reset transistor 13. The charge storage region 35 is a diffusion region provided on the substrate. One of a source and a drain of the amplification transistor 11 is electrically connected to one of a source and a drain of the selection transistor 12.

The photoelectric converter 110, more specifically, the photoelectric conversion film 111, converts light into electric charge. The electric charge is stored in the charge storage node 30. A power supply voltage is supplied to the other of the source and the drain of the amplification transistor 11 through a voltage line 21. The amplification transistor 11 outputs a signal corresponding to the potential of the charge storage node 30 to a signal line 22 through the selection transistor 12. The selection transistor 12 determines timing at which the signal is to be output from the amplification transistor 11. More specifically, a voltage is supplied to a gate 12g of the selection transistor 12 included in the pixel 190 selected by a control circuit (not illustrated). Thus, the selection transistor 12 turns on and the signal is output from the other of the source and the drain of the selection transistor 12.

A reset voltage is supplied to the other of the source and the drain of the reset transistor 13 through a voltage line 23. The reset transistor 13 resets the electric charge stored in the charge storage node 30. More specifically, when a voltage is supplied to a gate 13g of the reset transistor 13, the reset transistor 13 turns on and the reset voltage is supplied to the charge storage node 30 to reset the electric charge of the charge storage node 30.

The reset transistor 13 is provided on the first substrate 141. The amplification transistor 11 and the selection transistor 12 are provided on the second substrate 142. The microlens 130, the color filter 120, the protective film 119, the photoelectric converter 110, the first wiring layers 151, the first substrate 141, the second wiring layers 152, and the second substrate 142 are arranged in that order. The first wiring layers 151 are disposed closer to a light incident side than the first substrate 141. The second wiring layers 152 are disposed closer to the light incident side than the second substrate 142.

FIG. 1C is a sectional view of a structure including the first substrate 141. The first wiring layers 151 include a wiring layer 151a and a wiring layer 151b. The photoelectric converter 110, the wiring layer 151a, the wiring layer 151b, and the first substrate 141 are arranged in that order. The second wiring layers 152 include a wiring layer 152a and a wiring layer 152b. The first substrate 141, the wiring layer 152a, the wiring layer 152b, and the second substrate 142 are arranged in that order.

The first wiring layers 151 are electrically connected to each other. The first wiring layers 151 are conductors and include, for example, a metal. In the illustrated example, the wiring layer 151a and the wiring layer 151b are electrically connected by a via 151x. The second wiring layers 152 are electrically connected to each other. The second wiring layers 152 are conductors and include, for example, a metal. In the illustrated example, the wiring layer 152a and the wiring layer 152b are electrically connected by a via 152x. The first via 161 extends through the first substrate 141 and electrically connects the wiring layer 151b and the wiring layer 152a. The first via 161 is a conductor and includes, for example, a metal. The first wiring layers 151, the second wiring layers 152, and the first via 161 are electrically connected to the charge storage region 35.

The via 166 electrically connects the wiring layer 151b and the charge storage region 35.

The imaging device 101 includes a first structural body 171 and a second structural body 172. The first structural body 171 includes the microlens 130, the color filter 120, the protective film 119, the photoelectric converter 110, the first wiring layers 151, and the first substrate 141. The second structural body 172 includes the second wiring layers 152 and the second substrate 142. The first structural body 171 and the second structural body 172 are joined to each other at a first joining interface 181.

As described below, when the imaging device 101 is manufactured, a structural body 170 including the first substrate 141 is formed, and is bonded to the second structural body 172. Specifically, the first joining interface 181 is a joining interface formed in this bonding process. After the bonding process, the first via 161 is formed.

The wiring layer 151b and the wiring layer 152a form a first pair of wiring layers 151b and 152a. The first via 161 directly connects the first pair of wiring layers 151b and 152a. This structure is suitable for providing a small, low-noise imaging device 101. The reason for this will now be described in detail in comparison with a first reference example.

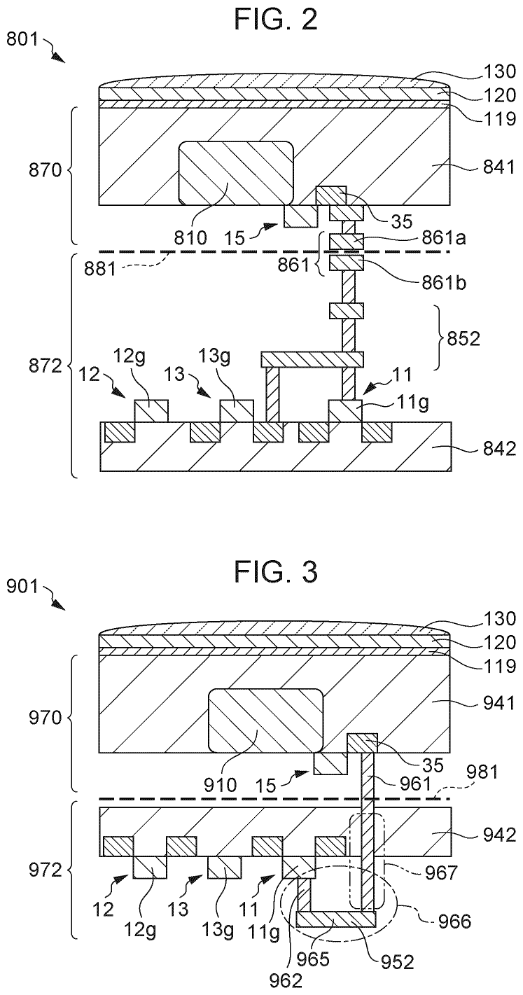

FIG. 2 is a sectional view of an imaging device 801 according to the first reference example. The imaging device 801 includes a photoelectric converter 810, a microlens 130, a color filter 120, a protective film 119, a transfer transistor 15, a reset transistor 13, an amplification transistor 11, a selection transistor 12, a first substrate 841, a second substrate 842, wiring layers 852, and a Cu—Cu bond 861. The Cu—Cu bond 861 includes a first Cu pad 861a and a second Cu pad 861b.

The photoelectric converter 810 is a photodiode provided on the first substrate 841. The transfer transistor 15 is provided on the first substrate 841. The reset transistor 13, the amplification transistor 11, and the selection transistor 12 are provided on the second substrate 842. The microlens 130, the color filter 120, the protective film 119, the first substrate 841, the wiring layers 852, and the second substrate 842 are arranged in that order.

One of a source and a drain of the transfer transistor 15 is connected to the photoelectric converter 810. The other of the source and the drain of the transfer transistor 15 forms a charge storage region 35. The charge storage region 35 is electrically connected to one of a source and a drain of the reset transistor 13 and a gate 11g of the amplification transistor 11 through the Cu—Cu bond 861 and the wiring layers 852 in that order.

The imaging device 801 includes a structural body 870 and a structural body 872. The structural body 870 includes the first Cu pad 861a and the first substrate 841. The structural body 872 includes the second Cu pad 861b, the wiring layers 852, and the second substrate 842. The structural body 870 and the structural body 872 are joined to each other by the Cu—Cu bond 861 at a joining interface 881. The use of the Cu—Cu bond 861 is disadvantageous in terms of providing a small, low-noise imaging device 801. This is because the Cu—Cu bond 861 tends to increase the size of the imaging device 801 and the parasitic capacitance of the charge storage node 30.

In contrast, as described above, in the present embodiment, the first via 161 directly connects the first pair of wiring layers 151b and 152a. The first pair of wiring layers 151b and 152a is connected by the first via 161 without using a Cu—Cu bond. More generally, the first pair of wiring layers 151b and 152a is connected by the first via 161 without using a pair of conductor pads. The first via 161 does not tend to increase the size of the imaging device 101 or the parasitic capacitance of the charge storage node 30. Therefore, this structure is suitable for providing a small, low-noise imaging device 101.

The imaging device 101 includes one or more pixels 190. Each of the one or more pixels 190 includes the first structural body 171, the second structural body 172, the first via 161, and the charge storage region 35.

In plan view, the first structural body 171, the second structural body 172, the first via 161, and the charge storage region 35 may be disposed at positions that overlap at least one of the microlens 130 and the color filter 120.

In the present embodiment, the wiring layer 151b is one of the first wiring layers 151 that is closest to the first substrate 141 in the first structural body 171. The wiring layer 151b may be the only wiring layer in the first structural body 171. Either structure is advantageous in terms of reducing the length of the first via 161. This is advantageous in terms of reducing the parasitic capacitance of the charge storage node 30.

In the present embodiment, the wiring layer 152a is one of the second wiring layers 152 that is closest to the first substrate 141 in the second structural body 172. The wiring layer 152a may be the only wiring layer in the second structural body 172. Either structure is advantageous in terms of reducing the length of the first via 161. This is advantageous in terms of reducing the parasitic capacitance of the charge storage node 30.

The first substrate 141 includes a first semiconductor layer 141x and a first oxide film 141y. The first via 161 extends through the first oxide film 141y. The first oxide film 141y prevents electrical conduction between the first via 161 and the first semiconductor layer 141x. More specifically, the first oxide film 141y is an embedded oxide film. The first oxide film 141y is embedded in the first substrate 141 to separate semiconductor devices in the first substrate 141. The embedded oxide film may reduce the parasitic capacitance of the charge storage node 30 due to the first semiconductor layer 141x. In the illustrated example, the first oxide film 141y extends through the first substrate 141. This structure is advantageous in terms of preventing electrical conduction between the first via 161 and the first semiconductor layer 141x. However, it is not necessary that the first oxide film 141y extend through the first substrate 141.

In the present embodiment, the first semiconductor layer 141x includes silicon. The first oxide film 141y is an insulating film. The first oxide film 141y includes silicon oxide.

As is clear from the above description, a first transistor is provided on the first substrate 141. A second transistor is provided on the second substrate 142. A third transistor is provided on the second substrate 142. More specifically, each of the one or more pixels 190 includes the first transistor, the second transistor, and the third transistor. The structure in which the transistors are separately provided on different substrates is advantageous in terms of increasing the size of individual transistors. This may contribute to providing low-noise transistors. More specifically, a low-noise transistor may be provided by increasing a gate length L and a gate width W of the transistor. Alternatively, the structure in which the transistors are separately provided on different substrates is advantageous in terms of reducing the size of the imaging device 101.

One of the first transistor and the second transistor may be the amplification transistor 11. To provide a low-noise amplification transistor 11 by increasing the size of the amplification transistor 11 is particularly advantageous in terms of providing a high-performance imaging device 101.

The other of the first transistor and the second transistor may be the reset transistor 13. The third transistor may be the selection transistor 12.

In the illustrated example, the first transistor is the reset transistor 13. The second transistor is the amplification transistor 11. The third transistor is the selection transistor 12.

In the present embodiment, the gate of the second transistor (amplification transistor 11 in the illustrated example) is disposed between the photoelectric converter 110 and the second substrate 142 in the thickness direction of the second substrate 142. This structure is advantageous in terms of providing a low-noise second transistor. The reason for this will now be described in detail in comparison with a second reference example.

FIG. 3 is a sectional view of an imaging device 901 according to the second reference example. The imaging device 901 includes a photoelectric converter 910, a microlens 130, a color filter 120, a protective film 119, a transfer transistor 15, a reset transistor 13, an amplification transistor 11, a selection transistor 12, a first substrate 941, a second substrate 942, a wiring layer 952, a via 961, and a via 962.

The photoelectric converter 910 is a photodiode provided on the first substrate 941. The transfer transistor 15 is provided on the first substrate 941. The reset transistor 13, the amplification transistor 11, and the selection transistor 12 are provided on the second substrate 942. The microlens 130, the color filter 120, the protective film 119, the first substrate 941, the second substrate 942, and the wiring layer 952 are arranged in that order.

One of a source and a drain of the transfer transistor 15 is connected to the photoelectric converter 910. The other of the source and the drain of the transfer transistor 15 forms a charge storage region 35. The charge storage region 35 is electrically connected to a gate 11g of the amplification transistor 11 through the via 961, the wiring layer 952, and the via 962 in that order.

The imaging device 901 includes a structural body 970 and a structural body 972. The structural body 970 includes the first substrate 941. The structural body 972 includes the wiring layer 952 and the second substrate 942. The structural body 970 and the structural body 972 are joined to each other at a joining interface 981.

In the second reference example, the via 961 extends from the first substrate 941 to the wiring layer 952 through the second substrate 942, and is connected to the wiring layer 952. The gate 11g of the amplification transistor 11 is closer to the wiring layer 952 than the second substrate 942, and is connected to the wiring layer 952 by the via 962. Thus, the via 961, the wiring layer 952, and the via 962 form an electrical path 965 that connects the charge storage region 35 and the gate 11g.

In FIG. 3, the gate 11g is positioned below the second substrate 942. The via 961 of the electrical path 965 extends downward from the charge storage region 35 through the second substrate 942. Then, a returning portion 966 of the electrical path 965 extends upward to the gate 11g. When the gate 11g is positioned below the second substrate 942 and the via 961 extends downward through the second substrate 942, the gate 11g cannot be easily disposed on the second substrate 942 in a surrounding region 967 around the via 961.

In contrast, as described above, in the present embodiment, the gate of the second transistor (amplification transistor 11 in the illustrated example) is disposed between the photoelectric converter 110 and the second substrate 142 in the thickness direction of the second substrate 142. In this structure, the charge storage region 35 can be electrically connected to the gate of the second transistor by the first via 161 without using a via that extends through the second substrate 142. Therefore, the location of the gate is not limited by the via that extends through the second substrate 142. This is advantageous in terms of avoiding an unnecessary reduction in the size of the second transistor and providing a low-noise second transistor.

In the present embodiment, the gate of the first transistor (reset transistor 13 in the illustrated example) is disposed between the photoelectric converter 110 and the first substrate 141 in the thickness direction of the first substrate 141. The gate of the third transistor (selection transistor 12 in the illustrated example) is disposed between the photoelectric converter 110 and the second substrate 142 in the thickness direction of the second substrate 142.

In the present embodiment, the reset transistor 13 is provided on the first substrate 141. The amplification transistor 11 is provided on the second substrate 142. The selection transistor 12 is provided on the second substrate 142. This structure is advantageous in terms of reducing the number of vias that extend through the substrates of the imaging device 101. By reducing the number of vias that extend through the substrates, the vias can be arranged in a smaller area. This is advantageous in terms of increasing the size of the transistors. In addition, when the number of vias extending through the substrates is reduced, the imaging device 101 can be more easily manufactured. This may lead to an increase in the reliability of the imaging device 101.

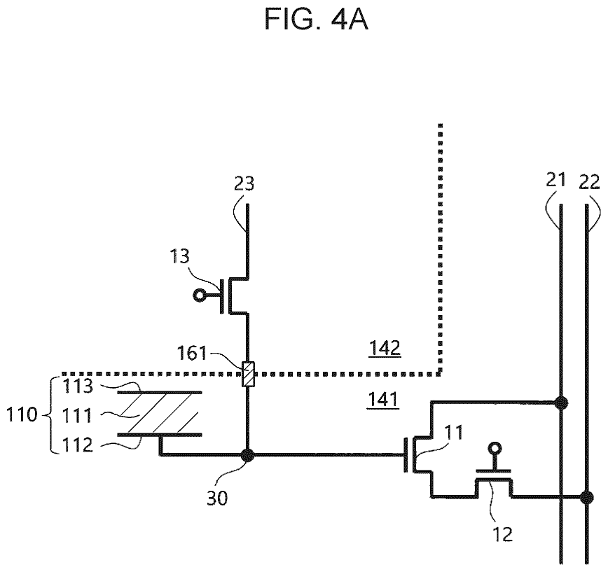

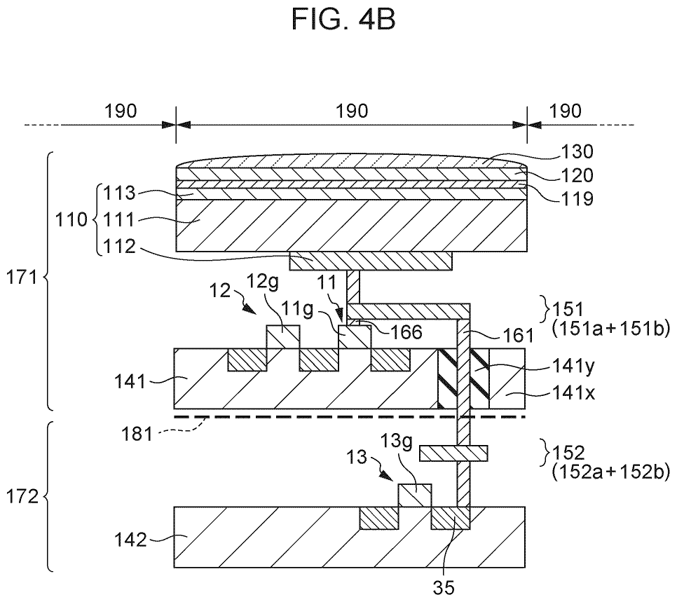

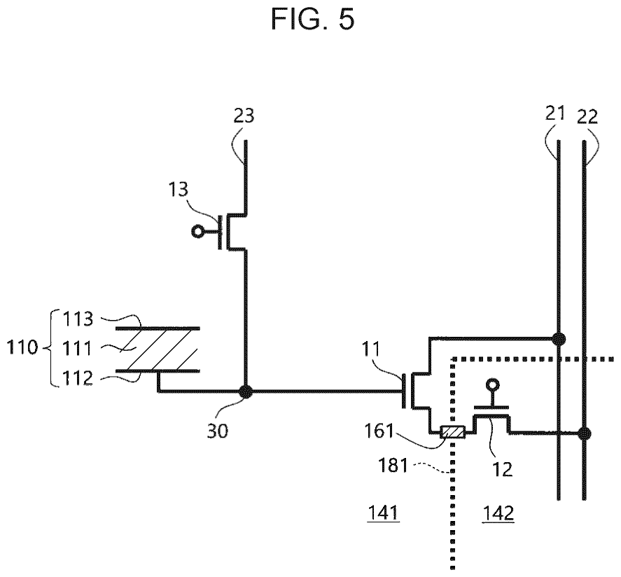

More specifically, in the present embodiment, each of the one or more pixels 190 includes the reset transistor 13, the amplification transistor 11, and the selection transistor 12. This also applies to examples illustrated in FIG. 4A to FIG. 5.

According to the studies by the present inventors, the arrangement of the transistors may be devised to reduce the number of vias that extend through the substrates to connect the transistors. Table 1 shows the result of the studies. Table 1 shows the relationship between the substrates on which the various transistors are disposed and the number of vias. More specifically, in Table 1,
“RX” represents the reset transistor 13.
“SF” represents the amplification transistor 11.
“SEL” represents the selection transistor 12.
“First Layer” represents the transistors provided on the first substrate 141.
“Second Layer” represents the transistors provided on the second substrate 142.
“Number of Vias” between “First Layer” and “Second Layer” represents the number of vias extending through the first substrate 141.

Here, the symbol “RX” is not intended to imply any limitation regarding the reset transistor 13. In addition, the symbols “SF”, “SEL”, and “OF” are also not intended to imply any limitation.

TABLE 1

| | Transistor Arrangement | | | | | |
|---|---|---|---|---|---|---|
| | (1) | (2) | (3) | (4) | (5) | (6) |
| First Layer | — | — | — | RX | RX | SF |
| | RX | SF | SEL | SF | SEL | SEL |
| Number of Vias | 1 | 2 | 2 | 1 | 2 | 1 |
| Second Layer | SF | RX | RX | — | — | — |
| | SEL | SEL | SF | SEL | SF | RX |

As is clear from FIG. 1B, the first embodiment corresponds to transistor arrangement (1) in Table 1.

FIGS. 4A and 4B are a circuit diagram and a sectional view, respectively, of an imaging device having transistor arrangement (6) in Table 1. FIG. 5 is a circuit diagram of an imaging device having transistor arrangement (4) in Table 1. The electrical circuits illustrated in FIGS. 1A, 4A, and 5 are electrically equivalent.

According to transistor arrangement (6) in Table 1, that is, in the example illustrated in FIGS. 4A and 4B, the amplification transistor 11 is provided on the first substrate 141. The selection transistor 12 is provided on the first substrate 141. The reset transistor 13 is provided on the second substrate 142.

According to transistor arrangement (4) in Table 1, that is, in the example illustrated in FIG. 5, the reset transistor 13 is provided on the first substrate 141. The amplification transistor 11 is provided on the first substrate 141. The selection transistor 12 is provided on the second substrate 142.

Various modifications are possible in the imaging device 101. The number of wiring layers included in the first wiring layers 151 is not particularly limited, and may be two as illustrated, three, or four or more. The number of wiring layers included in the second wiring layers 152 is not particularly limited, and may be two as illustrated, three, or four or more. Some of the elements included in the imaging device 101 may be omitted. For example, the protective film 119, the color filter 120, and the microlens 130 may be omitted. The number of pixels 190 included in the imaging device 101 may be one or more. The first oxide film 141y may be omitted.

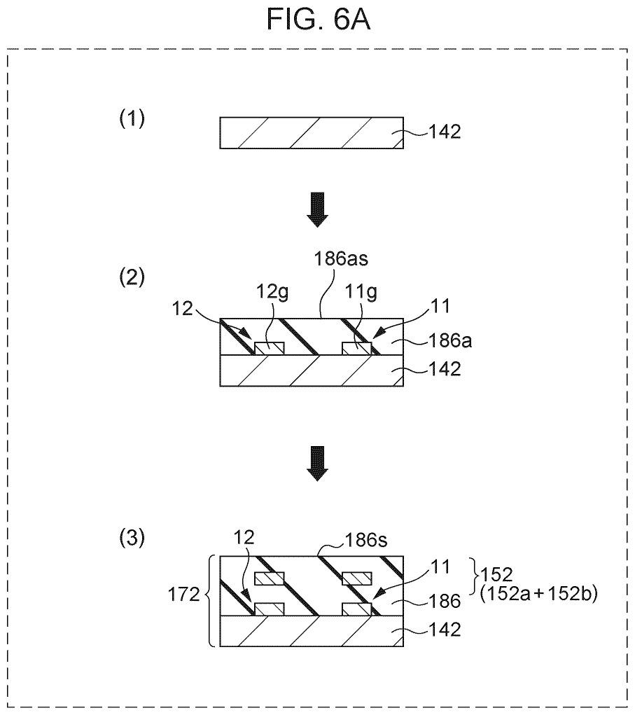

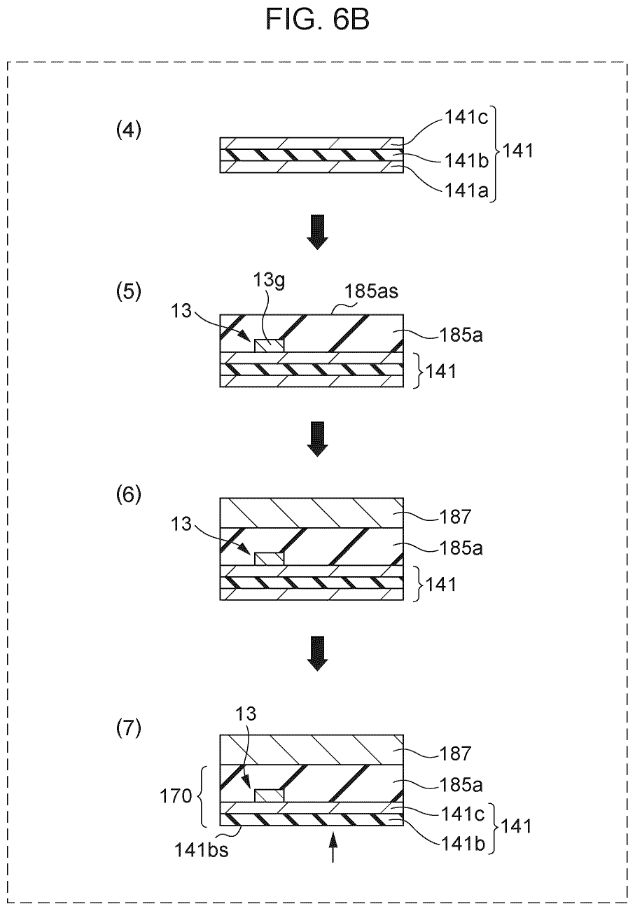

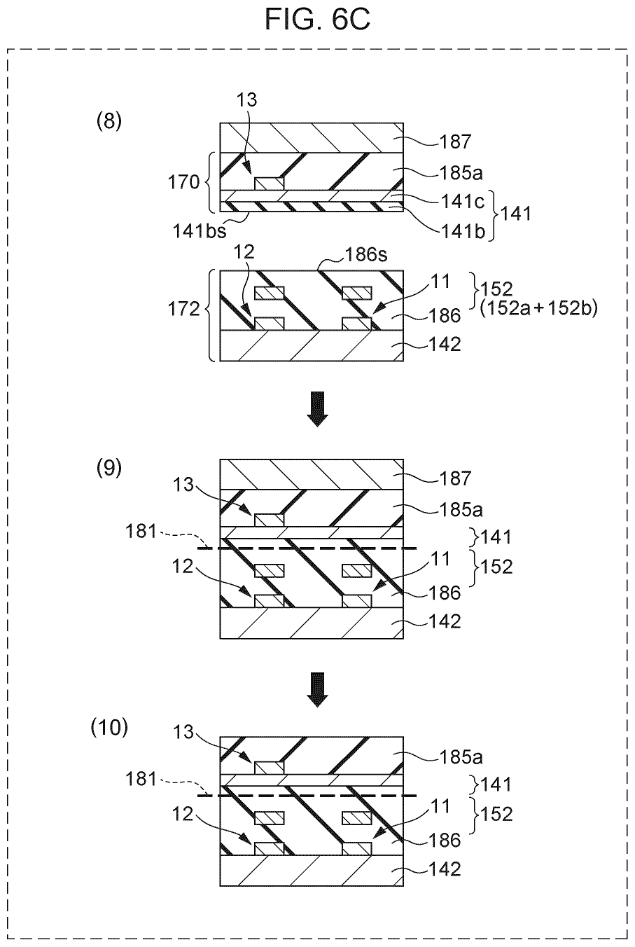

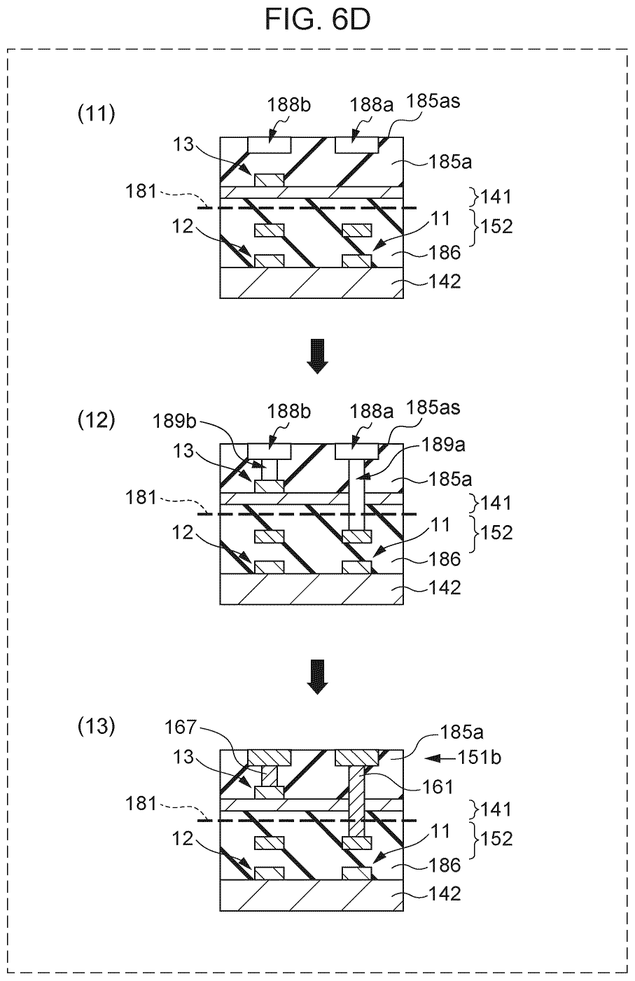

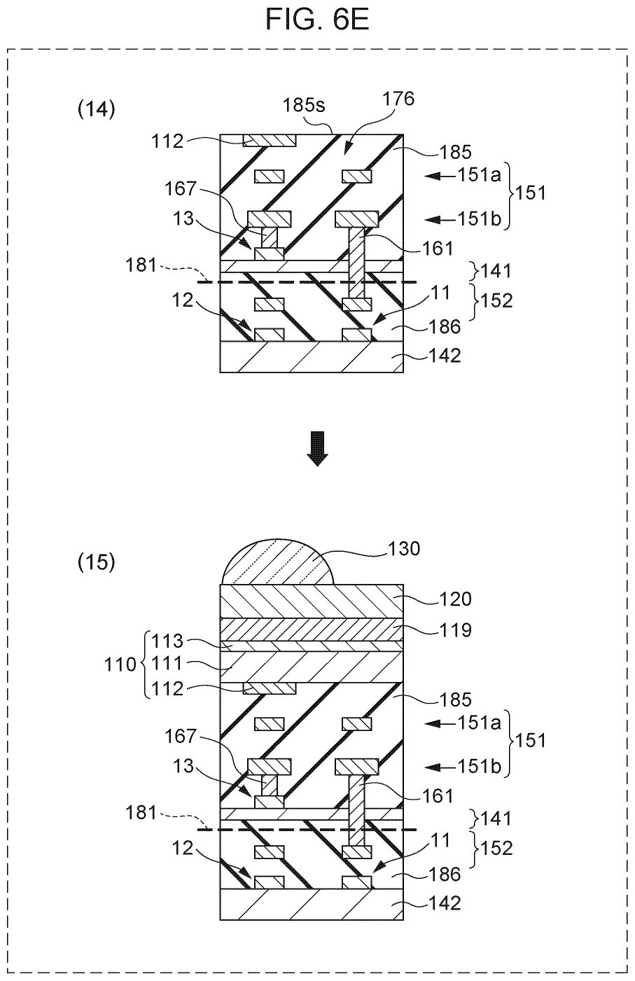

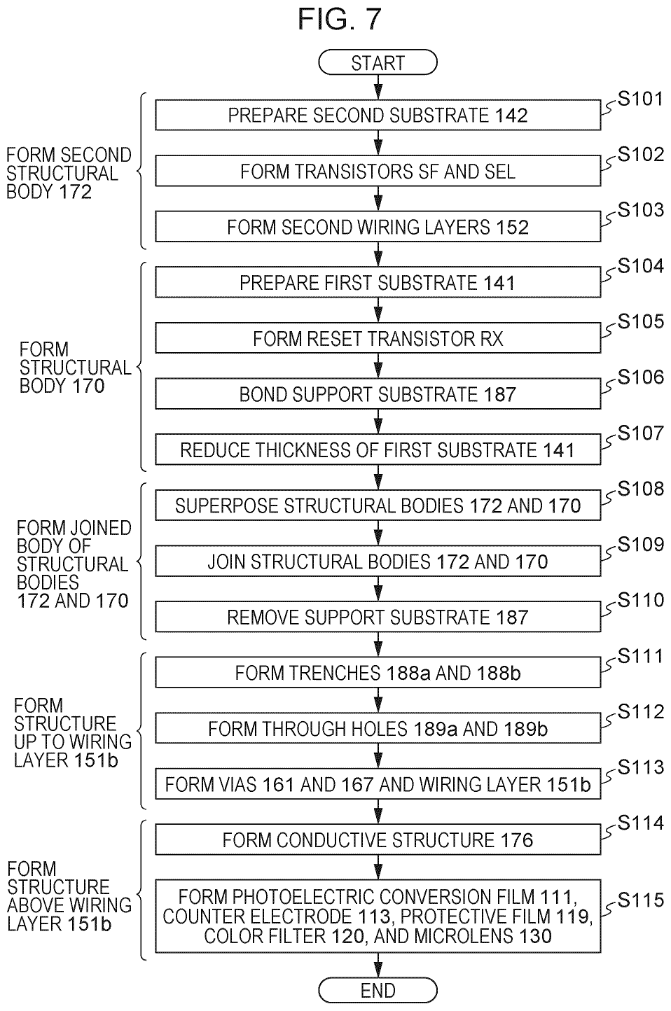

FIGS. 6A to 6E illustrate a method for manufacturing the imaging device 101 according to the first embodiment. FIG. 7 is a flowchart of the method for manufacturing the imaging device 101 according to the first embodiment. The method for manufacturing the imaging device 101 will now be described with reference to FIGS. 6A to 6E and FIG. 7.

In parts (1) to (3) of FIG. 6A and steps S101 to S103 in FIG. 7, the second structural body 172 is formed. In parts (4) to (7) of FIG. 6B and steps S104 to S107 in FIG. 7, the structural body 170 is formed. In parts (8) to (10) of FIG. 6C and steps S108 to S110 in FIG. 7, a joined body including the second structural body 172 and the structural body 170 is formed. In parts (11) to (13) of FIG. 6D and steps S111 to S113 in FIG. 7, the structure up to the wiring layer 151b is formed. In parts (14) and (15) of FIG. 6E and steps S114 and S115 in FIG. 7, the structure above the wiring layer 151b is formed. The method for manufacturing the imaging device 101 will now be described.

In step S101, as illustrated in part (1) of FIG. 6A, the second substrate 142 is prepared.

Next, in step S102, as illustrated in part (2) of FIG. 6A, the amplification transistor 11 and the selection transistor 12 are formed on the second substrate 142. An insulating film 186a is formed above the second substrate 142 to cover the amplification transistor 11 and the selection transistor 12. Then, an upper surface 186as of the insulating film 186a is flattened. In this example, the insulating film 186a is a silicon oxide film.

Next, in step S103, as illustrated in part (3) of FIG. 6A, the second wiring layers 152 are formed. More specifically, a wiring layer and an insulating portion are alternately formed. Thus, a structure in which the second wiring layers 152 are covered by an insulating film 186 is formed above the second substrate 142. An upper surface 186s of the insulating film 186 is flattened. The insulating film 186 includes the insulating film 186a. In this example, the insulating film 186 is a silicon oxide film. Thus, the second structural body 172 is obtained.

In step S104, as illustrated in part (4) of FIG. 6B, the first substrate 141 is prepared. In this example, a silicon-on-insulator (SOI) substrate is prepared as the first substrate 141. More specifically, the prepared first substrate 141 is a multilayer substrate including a silicon film 141a, an insulating film 141b, and a silicon film 141c arranged in that order. In this example, the insulating film 141b is a silicon oxide film.

Next, in step S105, as illustrated in part (5) of FIG. 6B, the reset transistor 13 is formed on the first substrate 141. An insulating film 185a is formed above the first substrate 141 to cover the reset transistor 13. Then, an upper surface 185as of the insulating film 185a is flattened.

Next, in step S106, as illustrated in part (6) of FIG. 6B, a support substrate 187 is bonded to the upper surface 185as of the insulating film 185a.

Next, in step S107, as illustrated in part (7) of FIG. 6B, the thickness of the first substrate 141 is reduced from a side opposite to the side at which the support substrate 187 is provided. The thickness is reduced by, for example, grinding. In the illustrated example, the thickness is reduced to selectively remove the silicon film 141a so that a lower surface 141bs of the insulating film 141b is exposed. Thus, the structural body 170 is obtained. The structural body 170 is supported by the support substrate 187 and includes the first substrate 141 from which the silicon film 141a is removed.

Next, in step S108, as illustrated in part (8) of FIG. 6C, the lower surface 141bs of the insulating film 141b and the upper surface 186s of the insulating film 186 are superposed. Thus, the second structural body 172 and the structural body 170 are superposed.

Next, in step S109, as illustrated in part (9) of FIG. 6C, the lower surface 141bs and the upper surface 186s are joined. The joining process is, for example, performed by plasma activation or by applying pressure. Thus, the second structural body 172 and the structural body 170 are joined together. Part (9) of FIG. 6C illustrates the first joining interface 181, which is the joining interface between the second structural body 172 and the structural body 170.

Next, in step S110, as illustrated in part (10) of FIG. 6C, the support substrate 187 is removed from the structural body 170.

Next, in step S111, as illustrated in part (11) of FIG. 6D, a trench 188a and a trench 188b are formed in the upper surface 185as of the insulating film 185a.

Next, in step S112, as illustrated in part (12) of FIG. 6D, a first through hole 189a and a through hole 189b are formed. The first through hole 189a communicates with the trench 188a and extends into the insulating film 185a, the silicon film 141c, the insulating film 141b, and the insulating film 186 in that order to expose the wiring layer 152a. The through hole 189b communicates with the trench 188b and extends into the insulating film 185a to expose the gate 13g of the reset transistor 13.

Next, in step S113, as illustrated in part (13) of FIG. 6D, the first through hole 189a, the trench 188a, the through hole 189b, and the trench 188b are filled with a conductor. The conductor is, for example, a metal. The conductor in the first through hole 189a forms the first via 161. The conductor in the through hole 189b forms the via 167. The conductor in the trench 188a and the trench 188b forms the wiring layer 151b. In the present embodiment, the first via 161, the via 167, and the wiring layer 151b are filled with the conductor in a single process.

Next, in step S114, as illustrated in part (14) of FIG. 6E, a conductive structure 176 above the wiring layer 151b is formed. The conductive structure 176 includes portions of the first wiring layers 151 other than the wiring layer 151b and the pixel electrode 112. Step S114 will now be described in detail.

First, in step S114, portions of the first wiring layers 151 other than the wiring layer 151b are formed. More specifically, one wiring layer is formed, and then one insulating portion is formed. Alternatively, a wiring layer and an insulating portion are alternately formed. Thus, a structure in which the first wiring layers 151 are covered by an insulating film 185 is formed above the second substrate 142. An upper surface 185s of the insulating film 185 is flattened. The insulating film 185 includes the insulating film 185a. In this example, the insulating film 185 is a silicon oxide film.

Second, in step S114, the pixel electrode 112 is formed on the upper surface 185s of the insulating film 185.

Next, in step S115, as illustrated in part (15) of FIG. 6E, the photoelectric conversion film 111, the counter electrode 113, the protective film 119, the color filter 120, and the microlens 130 are formed above the conductive structure 176. The photoelectric conversion film 111 is formed by, for example, vacuum deposition or spin coating. As described above, in the present embodiment, the photoelectric conversion film 111 includes an organic material.

As is clear from the above description, the manufacturing method according to the present embodiment includes a first joining step, a first hole-forming step, a first via-forming step, and a first film-forming step performed in that order. In the first joining step, the structural body 170 including the first substrate 141 is joined to the second structural body 172. In the first hole-forming step, the first through hole 189a is formed in the first substrate 141. In the first via-forming step, the first through hole 189a is filled with a first conductor to form the first via 161. In the first film-forming step, the photoelectric conversion film 111 is formed.

In the above-described manufacturing method, the wiring layers that belong to the first wiring layers 151 are not formed immediately after step S105. Accordingly, the lengths of the first through hole 189a and the first via 161 may be reduced. As a result, the imaging device 101 can be more easily manufactured. This may lead to an increase in the reliability of the imaging device 101. However, some or all of the first wiring layers 151 may be formed immediately after step S105.

As is clear from the above description, the first wiring layers 151 may be replaced by a single wiring layer. In this case, no wiring layer is formed in step S114. In addition, the second wiring layers 152 may be replaced by a single wiring layer. In this case, one wiring layer is formed in step S103.

It is not necessary that the first substrate 141 prepared in step S104 be an SOI substrate. For example, a silicon substrate may be prepared as the first substrate 141 in step S104. In such a case, for example, an insulating film is formed on the first substrate 141. Then, in step S109, the insulating film is joined to the insulating film 186. The insulating film formed on the first substrate 141 is, for example, a silicon oxide film.

In step S109, the second structural body 172 and the structural body 170 may be joined together by, for example, an adhesive, bumps, or a pair of conductor pads. In such a case, preparations corresponding to the joining method may be performed. A bond provided by the pair of conductor pads is, for example, a Cu—Cu bond.

The length of the first through hole 189a and the first via 161 can be reduced by performing the thickness reducing process in step S107. However, it is not necessary to perform the thickness reducing process. In addition, in step S113, it is not necessary to form the first via 161, the via 167, and the wiring layer 151b in a single process using a conductor.

The formation of the first oxide film 141y is not discussed in the above description. The first oxide film 141y may be formed by an appropriate method.

Other embodiments will now be described. In the following description, elements of embodiments that are the same as those in previously described embodiments are denoted by the same reference signs, and description thereof may be omitted. The description of each embodiment may be applied to other embodiments as long as there are no technical contradictions. The embodiments may be combined with each other as long as there are no technical contradictions.

### Second Embodiment

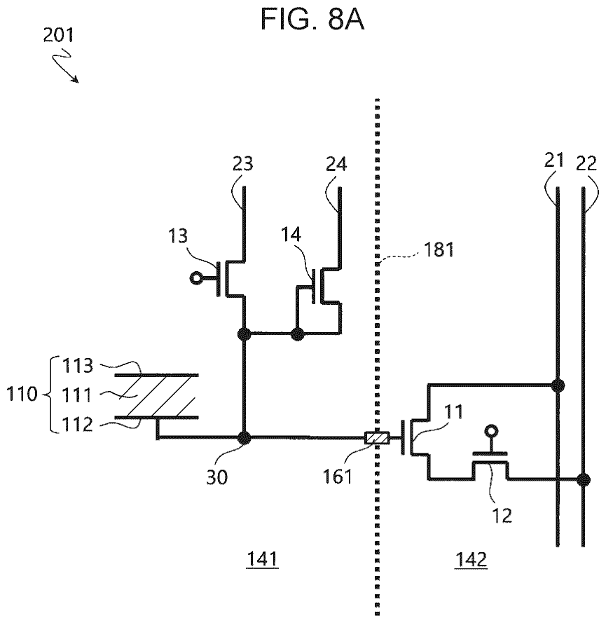

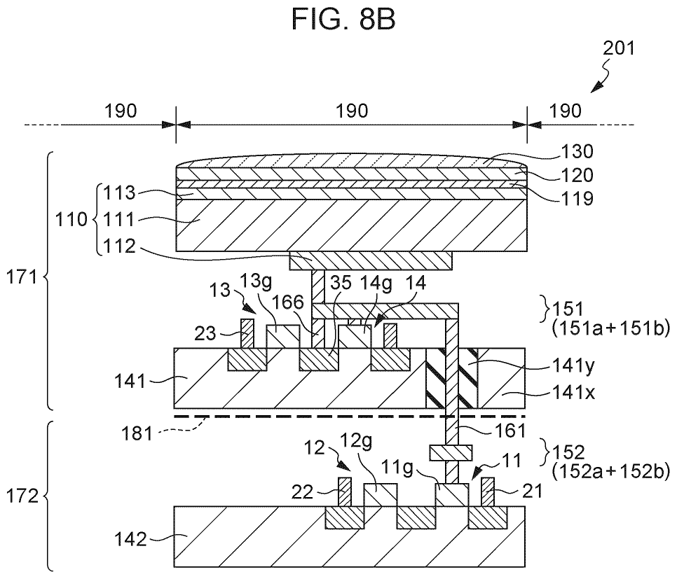

FIGS. 8A and 8B are a circuit diagram and a sectional view, respectively, of an imaging device 201 according to a second embodiment. The imaging device 201 includes an overflow transistor 14. The overflow transistor 14 is included in a pixel 190 of the imaging device 201. In a typical example, the overflow transistor 14 is included in each of multiple pixels 190 of the imaging device 201.

A photoelectric converter 110 is electrically connected to one of a source and a drain of a reset transistor 13, one of a source and a drain of the overflow transistor 14, a gate 14g of the overflow transistor 14, and a gate 11g of an amplification transistor 11. More specifically, a pixel electrode 112 is electrically connected to these elements. The one of the source and the drain of the reset transistor 13 forms a charge storage region 35. The one of the source and the drain of the overflow transistor 14 also forms the charge storage region 35. In other words, the charge storage region 35 is shared by the reset transistor 13 and the overflow transistor 14. A first via 161 is electrically connected to the charge storage region 35.

A voltage is applied to the other of the source and the drain of the overflow transistor 14 through a voltage line 24. As described above, the gate 14g of the overflow transistor 14 is electrically connected to the charge storage region 35. When strong light is incident on the photoelectric converter 110, the electric charge of the charge storage region 35 increases, and the overflow transistor 14 turns on. Accordingly, excessive electric charge stored in the charge storage region 35 is discharged through the overflow transistor 14. Thus, the various transistors are protected, and the safety of the imaging device 201 is ensured.

The imaging device 201 includes four transistors, which are the reset transistor 13, the overflow transistor 14, the amplification transistor 11, and a selection transistor 12. Two of the four transistors are provided on a first substrate 141, and the remaining two transistors are provided on a second substrate 142. The structure in which the transistors are grouped in pairs and in which the pairs of transistors are separately provided on different substrates is advantageous in terms of increasing the size of individual transistors. Alternatively, this structure is advantageous in terms of reducing the size of the imaging device 201.

The gate 14g of the overflow transistor 14 is disposed between the photoelectric converter 110 and the first substrate 141 in the thickness direction of the first substrate 141.

The reset transistor 13 and the overflow transistor 14 are provided on the first substrate 141. The amplification transistor 11 and the selection transistor 12 are provided on the second substrate 142. This structure is advantageous in terms of reducing the number of vias that extend through the substrates of the imaging device 201.

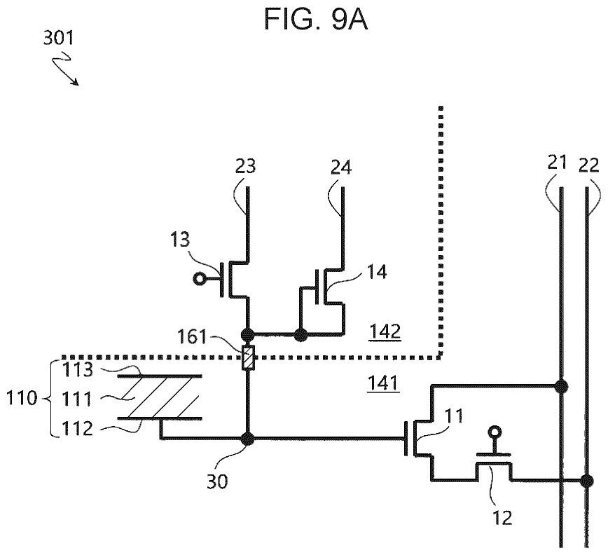

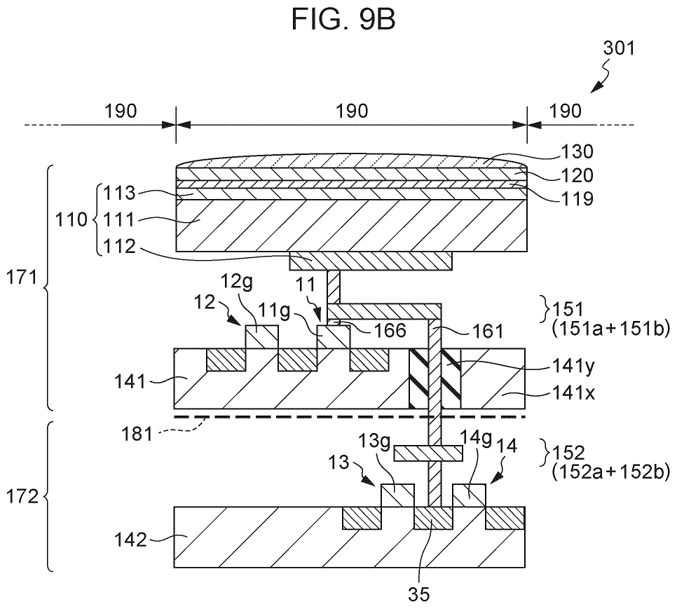

More specifically, each of the one or more pixels 190 includes the reset transistor 13, the overflow transistor 14, the amplification transistor 11, and the selection transistor 12. This also applies to examples illustrated in FIG. 9A to FIG. 19.

According to the studies by the present inventors, similarly to the first embodiment, also in the second embodiment, the arrangement of the transistors may be devised to reduce the number of vias that extend through the substrates to connect the transistors. Table 2 shows the result of the studies. Table 2 shows the relationship between the substrates on which the various transistors are disposed and the number of vias. More specifically, in Table 2,
“OF” represents the overflow transistor 14.

TABLE 2

| | Transistor Arrangement | | | | | |
|---|---|---|---|---|---|---|
| | (1) | (2) | (3) | (4) | (5) | (6) |
| First Layer | OF | OF | OF | RX | RX | SF |
| | RX | SF | SEL | SF | SEL | SEL |
| Number of Vias | 1 | 2 | 2 | 2 | 2 | 1 |
| Second Layer | SF | RX | RX | OF | OF | OF |
| | SEL | SEL | SF | SEL | SF | RX |

As is clear from FIG. 8B, the second embodiment corresponds to transistor arrangement (1) in Table 2.

A method for manufacturing the imaging device 201 according to the second embodiment is obtained by adding the formation of the overflow transistor 14 to the method for manufacturing imaging device 101 according to the first embodiment. More specifically, in step S105, the overflow transistor 14 is formed on the first substrate 141 together with the reset transistor 13. An insulating film 185a is formed above the first substrate 141 to cover the reset transistor 13 and the overflow transistor 14.

### Third Embodiment

FIGS. 9A and 9B are a circuit diagram and a sectional view, respectively, of an imaging device 301 according to a third embodiment.

A reset transistor 13 and an overflow transistor 14 are provided on a second substrate 142. An amplification transistor 11 and a selection transistor 12 are provided on a first substrate 141.

A via 166 electrically connects a wiring layer 151b to a gate 11g of the amplification transistor 11.

In the present embodiment, the gate 11g of the amplification transistor 11 and a gate 12g of the selection transistor 12 are disposed between a photoelectric converter 110 and the first substrate 141 in the thickness direction of the first substrate 141. A gate 13g of the reset transistor 13 and a gate 14g of the overflow transistor 14 are disposed between the photoelectric converter 110 and the second substrate 142 in the thickness direction of the second substrate 142.

The reset transistor 13 and the overflow transistor 14 are provided on the second substrate 142. The amplification transistor 11 and the selection transistor 12 are provided on the first substrate 141. This structure is advantageous in terms of reducing the number of vias that extend through the substrates of the imaging device 301.

As is clear from FIG. 9B, the third embodiment corresponds to transistor arrangement (6) in Table 2.

A method for manufacturing the imaging device 301 according to the third embodiment is obtained by changing a step related to the transistors in the method for manufacturing the imaging device 201 according to the second embodiment. Specifically, in step S102, the reset transistor 13 and the overflow transistor 14 are formed on the second substrate 142. An insulating film 186a is formed above the second substrate 142 to cover the reset transistor 13 and the overflow transistor 14. In step S105, the amplification transistor 11 and the selection transistor 12 are formed. An insulating film 185a is formed above the first substrate 141 to cover the amplification transistor 11 and the selection transistor 12. In step S112, a through hole 189b communicates with the trench 188b and extends into the insulating film 185a to expose the gate 12g of the selection transistor 12.

The electrical circuit illustrated in FIG. 9A according to the third embodiment and the electrical circuit illustrated in FIG. 8A according to second embodiment are electrically equivalent. Here, a comparison between the second and third embodiments will be discussed. In the third embodiment, a first via 161 extends through the substrate on which the amplification transistor 11 is provided, which is the first substrate 141. In contrast, in the second embodiment, the first via 161 does not extend through the substrate on which the amplification transistor 11 is provided, which is the second substrate 142. In the second embodiment, the area in which the amplification transistor 11 is mountable on the second substrate 142 is less likely to be limited by the first via 161. This is advantageous in terms of increasing the size of the amplification transistor 11.

### Fourth Embodiment

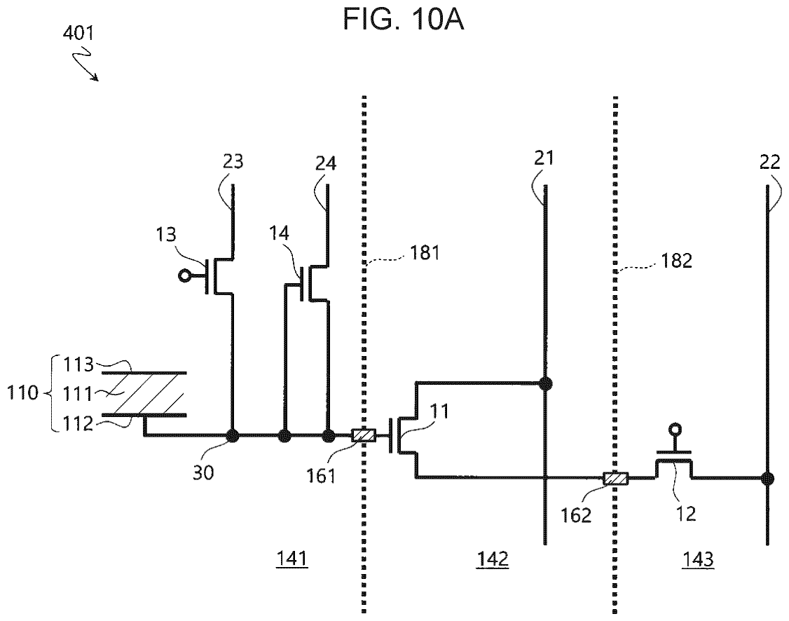

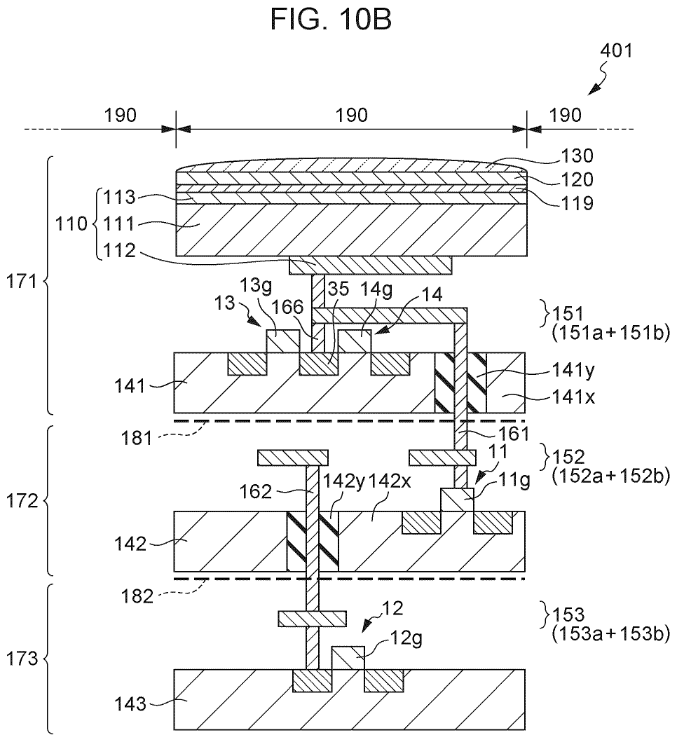

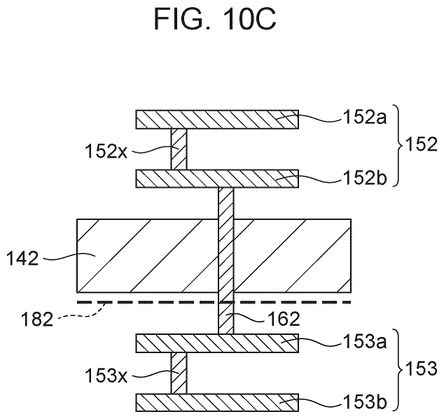

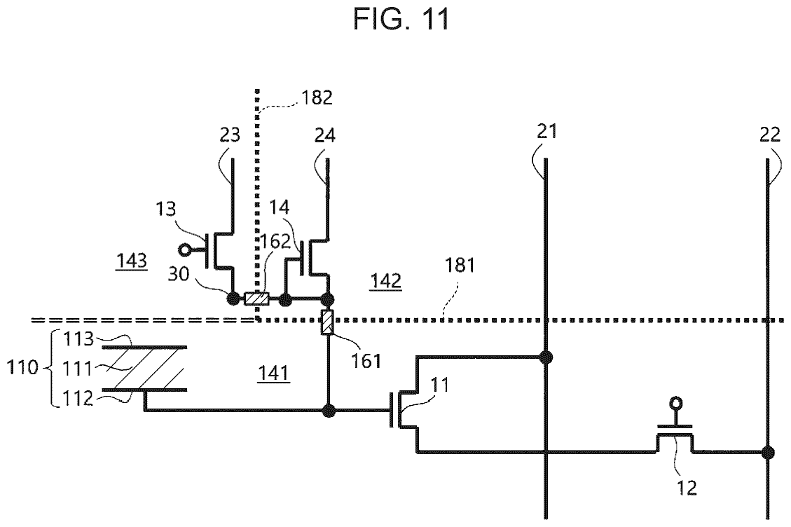

FIGS. 10A and 10B are a circuit diagram and a sectional view, respectively, of an imaging device 401 according to a fourth embodiment. The imaging device 401 includes a third substrate 143, third wiring layers 153, and a second via 162. These elements are included in a pixel 190 of the imaging device 401. In a typical example, these elements are included in each of multiple pixels 190 of the imaging device 401.

A reset transistor 13 and an overflow transistor 14 are provided on a first substrate 141. An amplification transistor 11 is provided on a second substrate 142. A selection transistor 12 is provided on the third substrate 143. A microlens 130, a color filter 120, a protective film 119, a photoelectric converter 110, first wiring layers 151, the first substrate 141, second wiring layers 152, the second substrate 142, the third wiring layers 153, and the third substrate 143 are arranged in that order. The third wiring layers 153 are disposed closer to a light incident side than the third substrate 143.

FIG. 10C is a sectional view of a structure including the second substrate 142. The third wiring layers 153 include a wiring layer 153a and a wiring layer 153b. The second substrate 142, the wiring layer 153a, the wiring layer 153b, and the third substrate 143 are arranged in that order.

The third wiring layers 153 are electrically connected to each other. The third wiring layers 153 are conductors and include, for example, a metal. In the illustrated example, the wiring layer 153a and the wiring layer 153b are electrically connected by a via 153x. The second via 162 extends through the second substrate 142 and electrically connects a wiring layer 152b and the wiring layer 153a. The second via 162 is a conductor and includes, for example, a metal. The second wiring layers 152, the third wiring layers 153, and the second via 162 are electrically connected to a charge storage region 35.

The imaging device 401 includes a third structural body 173. The third structural body 173 includes the third wiring layers 153 and the third substrate 143. A second structural body 172 and the third structural body 173 are joined to each other at a second joining interface 182.

As described below, when the imaging device 401 is manufactured, a structural body including the second substrate 142 is formed, and is bonded to the third structural body 173. Specifically, the second joining interface 182 is a joining interface formed in this bonding process. After the bonding process, the second via 162 is formed.

The wiring layer 152b and the wiring layer 153a form a second pair of wiring layers 152b and 153a. The second via 162 directly connects the second pair of wiring layers 152b and 153a. The second pair of wiring layers 152b and 153a is connected by the second via 162 without using a Cu—Cu bond. This structure is suitable for providing a small, low-noise imaging device 401. More generally, the second pair of wiring layers 152b and 153a is connected by the second via 162 without using a pair of conductor pads.

The imaging device 401 includes one or more pixels 190. Each of the one or more pixels 190 includes a first structural body 171, the second structural body 172, the third structural body 173, a first via 161, the second via 162, and the charge storage region 35.

In plan view, the first structural body 171, the second structural body 172, the third structural body 173, the first via 161, the second via 162, and the charge storage region 35 may be disposed at positions that overlap at least one of the microlens 130 and the color filter 120.

In the present embodiment, the wiring layer 152b is one of the second wiring layers 152 that is closest to the second substrate 142 in the second structural body 172. The wiring layer 152b may be the only wiring layer in the second structural body 172.

In the present embodiment, the wiring layer 153a is one of the third wiring layers 153 that is closest to the second substrate 142 in the third structural body 173. The wiring layer 153a may be the only wiring layer in the third structural body 173.

The first substrate 141 may include a first semiconductor layer 141x and a first oxide film 141y. The first via 161 may extend through the first oxide film 141y. More specifically, the first oxide film 141y may be an embedded oxide film. The first oxide film 141y may be embedded in the first substrate 141 to separate semiconductor devices in the first substrate 141. In one example, the first oxide film 141y extends through the first substrate 141. However, it is not necessary that the first oxide film 141y extend through the first substrate 141.

The second substrate 142 may include a second semiconductor layer 142x and a second oxide film 142y. The second via 162 may extend through the second oxide film 142y. More specifically, the second oxide film 142y may be an embedded oxide film. The second oxide film 142y may be embedded in the second substrate 142 to separate semiconductor devices in the second substrate 142. In one example, the second oxide film 142y extends through the second substrate 142. However, it is not necessary that the second oxide film 142y extend through the second substrate 142.

The first semiconductor layer 141x and the second semiconductor layer 142x may include silicon. The first oxide film 141y and the second oxide film 142y may be insulating films. The first oxide film 141y and the second oxide film 142y may include silicon oxide.

As is clear from the above description, a first transistor is provided on the first substrate 141. A second transistor is provided on the second substrate 142. A third transistor is provided on the third substrate 143. More specifically, each of the one or more pixels 190 includes the first transistor, the second transistor, and the third transistor. The structure in which the transistors are separately provided on three substrates is advantageous in terms of increasing the size of individual transistors. In the present embodiment, a fourth transistor is provided on the first substrate 141.

In the illustrated example, the first transistor is the reset transistor 13. The second transistor is the amplification transistor 11. The third transistor is the selection transistor 12. The fourth transistor is the overflow transistor 14.

As described above, to provide a high-performance imaging device 401, it is particularly advantageous to provide a low-noise amplification transistor 11 by increasing the size of the amplification transistor 11. In this respect, it is effective to provide the amplification transistor 11 on a substrate with a relatively small number of transistors. In the present embodiment, in each pixel 190, the number of transistors on the first substrate 141 is two, and the number of transistors on the second substrate 142 is one. The amplification transistor 11 is provided on the second substrate 142. Thus, the present embodiment satisfies the above-described condition.

In the present embodiment, the gate of the first transistor and the gate of the fourth transistor are disposed between the photoelectric converter 110 and the first substrate 141 in the thickness direction of the first substrate 141. The gate of the second transistor is disposed between the photoelectric converter 110 and the second substrate 142 in the thickness direction of the second substrate 142. The gate of the third transistor is disposed between the photoelectric converter 110 and the third substrate 143 in the thickness direction of the third substrate 143.

In the present embodiment, the reset transistor 13 is provided on the first substrate 141. The overflow transistor 14 is provided on the first substrate 141. The amplification transistor 11 is provided on the second substrate 142. The selection transistor 12 is provided on the third substrate 143. This structure is advantageous in terms of reducing the number of vias that extend through the substrates of the imaging device 401.

According to the studies by the present inventors, similarly to the first to third embodiments, also in the fourth embodiment, the arrangement of the transistors may be devised to reduce the number of vias that extend through the substrates to connect the transistors. Tables 3A to 3F show the results of the studies. Tables 3A to 3F show the relationship between the substrates on which the various transistors are disposed and the number of vias. More specifically, in Tables 3A to 3F,
“Third Layer” represents the transistors provided on the third substrate 143.
“Number of Vias” between “Second Layer” and “Third Layer” represents the number of vias extending through the second substrate 142.

TABLE 3A

| | Transistor Arrangement | | | | | |
|---|---|---|---|---|---|---|
| | (1) | (2) | (3) | (4) | (5) | (6) |
| First Layer | RX | RX | RX | RX | RX | RX |
| | OF | OF | SF | SF | SEL | SEL |
| Number of Vias | 1 | 1 | 2 | 2 | 2 | 2 |
| Second Layer | SF | SEL | OF | SEL | OF | SF |
| Number of Vias | 1 | 2 | 1 | 1 | 2 | 1 |
| Third Layer | SEL | SF | SEL | OF | SF | OF |

TABLE 3B

| | Transistor Arrangement | | | | | |
|---|---|---|---|---|---|---|
| | (7) | (8) | (9) | (10) | (11) | (12) |
| First Layer | OF | OF | OF | OF | SF | SF |
| | SF | SF | SEL | SEL | SEL | SEL |
| Number of Vias | 2 | 2 | 2 | 2 | 1 | 1 |
| Second Layer | RX | SEL | SF | RX | OF | RX |
| Number of Vias | 1 | 1 | 1 | 2 | 1 | 1 |
| Third Layer | SEL | RX | RX | SF | RX | OF |

TABLE 3C

| | Transistor Arrangement | | | | | |
|---|---|---|---|---|---|---|
| | (13) | (14) | (15) | (16) | (17) | (18) |
| First Layer | SF | SEL | OF | SEL | OF | SF |
| Number of Vias | 2 | 2 | 1 | 2 | 1 | 2 |
| Second Layer | RX | RX | RX | RX | RX | RX |
| | OF | OF | SF | SF | SEL | SEL |
| Number of Vias | 1 | 2 | 1 | 1 | 2 | 1 |
| Third Layer | SEL | SF | SEL | OF | SF | OF |

TABLE 3D

| | Transistor Arrangement | | | | | |
|---|---|---|---|---|---|---|
| | (19) | (20) | (21) | (22) | (23) | (24) |
| First Layer | RX | SEL | SF | RX | OF | RX |
| Number of Vias | 1 | 2 | 2 | 1 | 1 | 1 |
| Second Layer | OF | OF | OF | OF | SF | SF |
| | SF | SF | SEL | SEL | SEL | SEL |
| Number of Vias | 1 | 1 | 1 | 2 | 1 | 1 |
| Third Layer | SEL | RX | RX | SF | RX | OF |

TABLE 3E

| | Transistor Arrangement | | | | | |
|---|---|---|---|---|---|---|
| | (25) | (26) | (27) | (28) | (29) | (30) |
| First Layer | SF | SEL | OF | SEL | OF | SF |
| Number of Vias | 2 | 2 | 1 | 2 | 1 | 2 |
| Second Layer | SEL | SF | SEL | OF | SF | OF |
| Number of Vias | 1 | 1 | 2 | 2 | 2 | 2 |
| Third Layer | RX | RX | RX | RX | RX | RX |
| | OF | OF | SF | SF | SEL | SEL |

TABLE 3F

| | Transistor Arrangement | | | | | |
|---|---|---|---|---|---|---|
| | (31) | (32) | (33) | (34) | (35) | (36) |
| First Layer | RX | SEL | SF | RX | OF | RX |
| Number of Vias | 1 | 2 | 2 | 1 | 1 | 1 |
| Second Layer | SEL | RX | RX | SF | RX | OF |
| Number of Vias | 2 | 2 | 2 | 2 | 1 | 1 |
| Third Layer | OF | OF | OF | OF | SF | SF |
| | SF | SF | SEL | SEL | SEL | SEL |

As is clear from FIG. 10B, the fourth embodiment corresponds to transistor arrangement (1) in Table 3A.

FIG. 11 is a circuit diagram of an imaging device having transistor arrangement (11) in Table 3B. In the example illustrated in FIG. 11, the amplification transistor 11 is provided on the first substrate 141. The selection transistor 12 is provided on the first substrate 141. The overflow transistor 14 is provided on the second substrate 142. The reset transistor 13 is provided on the third substrate 143.

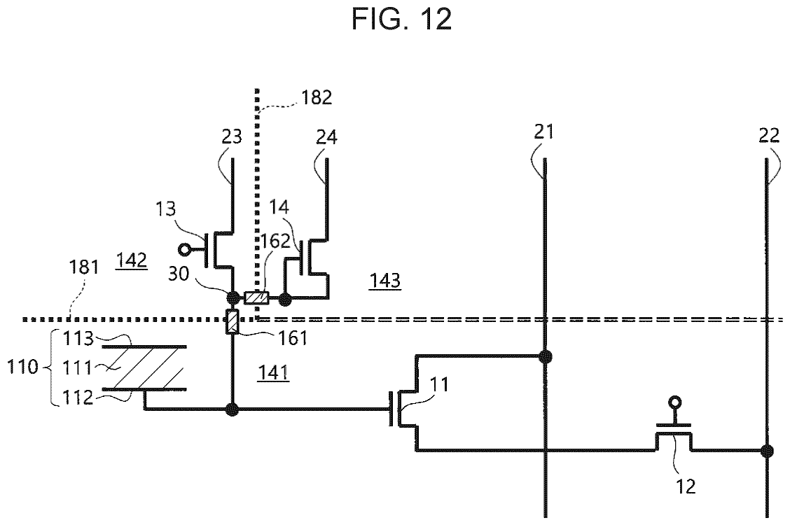

FIG. 12 is a circuit diagram of an imaging device having transistor arrangement (12) in Table 3B. In the example illustrated in FIG. 12, the amplification transistor 11 is provided on the first substrate 141. The selection transistor 12 is provided on the first substrate 141. The reset transistor 13 is provided on the second substrate 142. The overflow transistor 14 is provided on the third substrate 143.

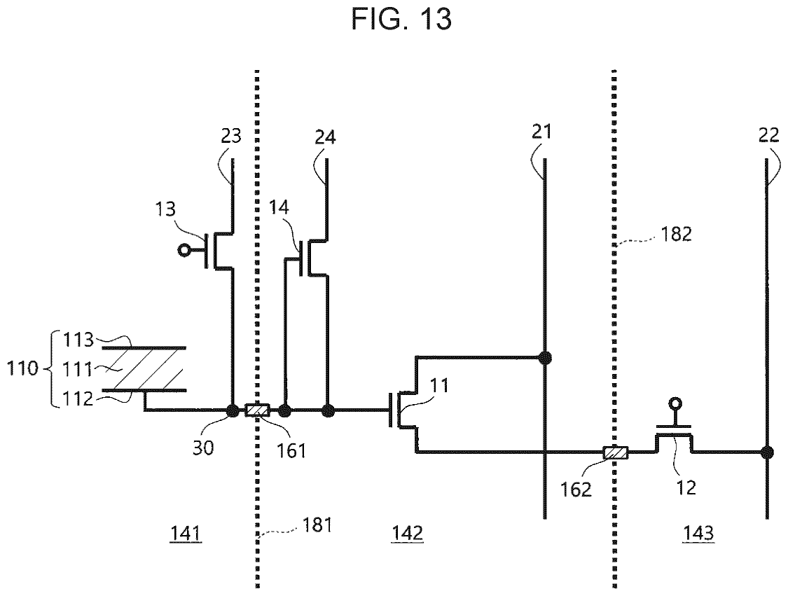

FIG. 13 is a circuit diagram of an imaging device having transistor arrangement (19) in Table 3D. In the example illustrated in FIG. 13, the reset transistor 13 is provided on the first substrate 141. The overflow transistor 14 is provided on the second substrate 142. The amplification transistor 11 is provided on the second substrate 142. The selection transistor 12 is provided on the third substrate 143.

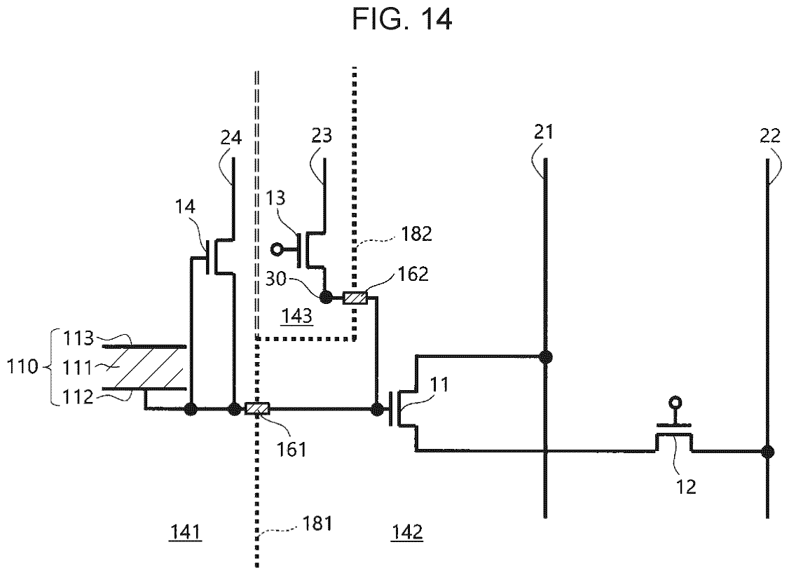

FIG. 14 is a circuit diagram of an imaging device having transistor arrangement (23) in Table 3D. In the example illustrated in FIG. 14, the overflow transistor 14 is provided on the first substrate 141. The amplification transistor 11 is provided on the second substrate 142. The selection transistor 12 is provided on the second substrate 142. The reset transistor 13 is provided on the third substrate 143.

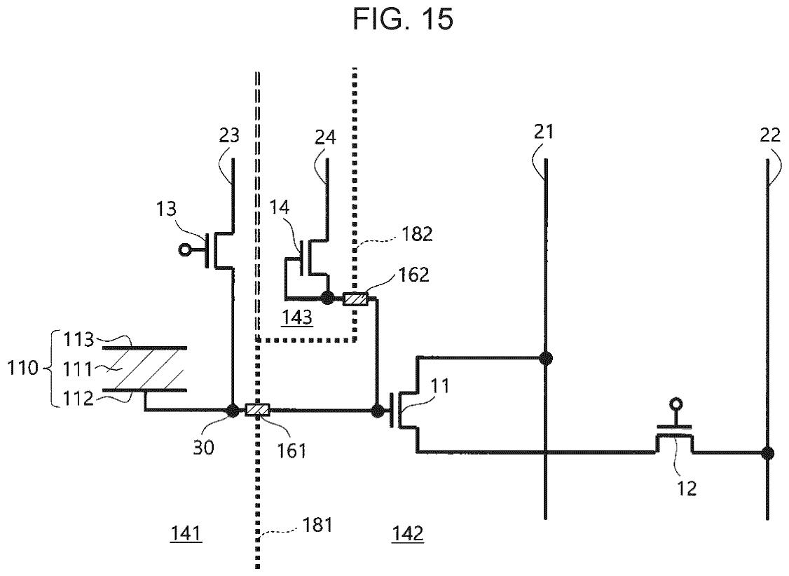

FIG. 15 is a circuit diagram of an imaging device having transistor arrangement (24) in Table 3D. In the example illustrated in FIG. 15, the reset transistor 13 is provided on the first substrate 141. The amplification transistor 11 is provided on the second substrate 142. The selection transistor 12 is provided on the second substrate 142. The overflow transistor 14 is provided on the third substrate 143.

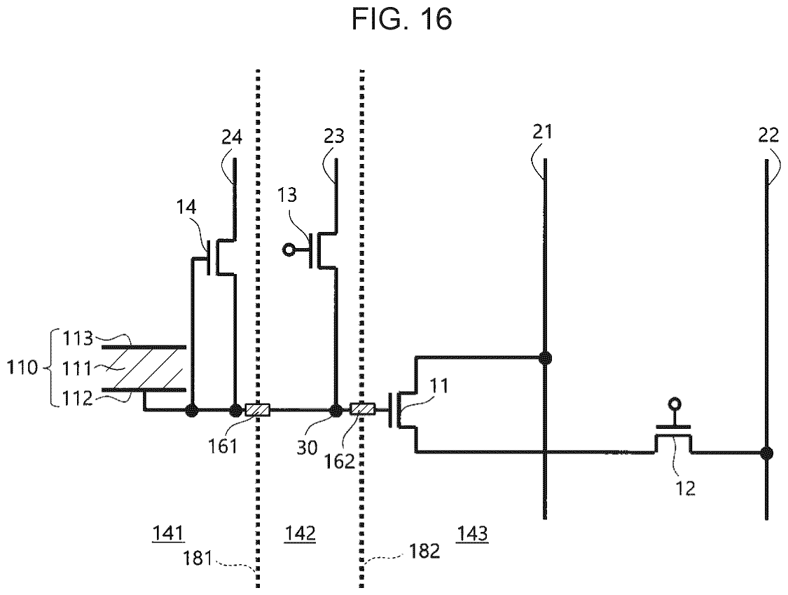

FIG. 16 is a circuit diagram of an imaging device having transistor arrangement (35) in Table 3F. In the example illustrated in FIG. 16, the overflow transistor 14 is provided on the first substrate 141. The reset transistor 13 is provided on the second substrate 142. The amplification transistor 11 is provided on the third substrate 143. The selection transistor 12 is provided on the third substrate 143.

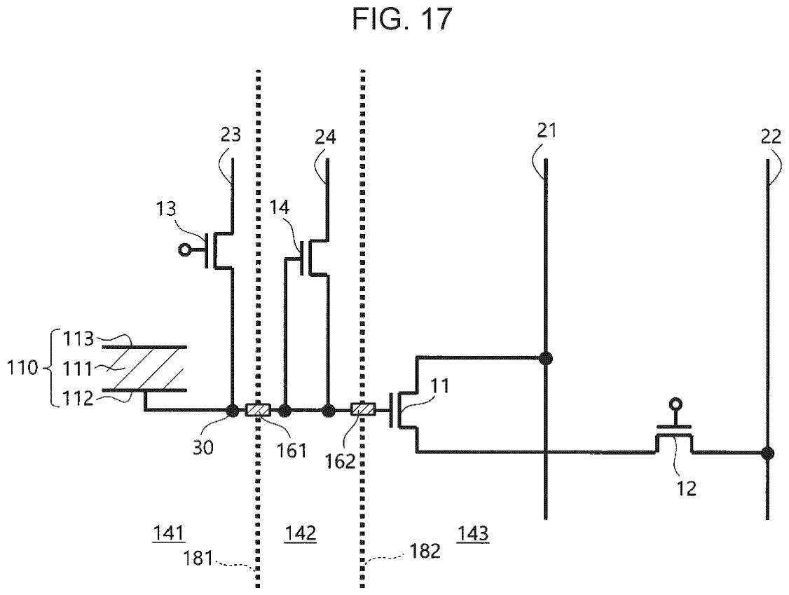

FIG. 17 is a circuit diagram of an imaging device having transistor arrangement (36) in Table 3F. In the example illustrated in FIG. 17, the reset transistor 13 is provided on the first substrate 141. The overflow transistor 14 is provided on the second substrate 142. The amplification transistor 11 is provided on the third substrate 143. The selection transistor 12 is provided on the third substrate 143.

The electrical circuits illustrated in FIG. 10A and FIGS. 11 to 17 are electrically equivalent.

Various modifications are possible in the imaging device 401. For example, the overflow transistor 14 may be omitted. The number of wiring layers included in the third wiring layers 153 is not particularly limited, and may be two as illustrated, three, or four or more. The second oxide film 142y may be omitted.

In the first embodiment, the method for producing the second structural body 172 is described with reference to steps S101 to S103. This description may be applied to the method for producing the third structural body 173 of the fourth embodiment by replacing terms as appropriate. The terms to be replaced include:
“second substrate 142” to be replaced with “third substrate 143”;
“amplification transistor 11 and selection transistor 12” to be replaced with “selection transistor 12”; and
“second wiring layers 152” to be replaced with “third wiring layers 153”.

In the first embodiment, the method for producing a portion of the first structural body 171 including the structural body 170 and the conductive structure 176 is described with reference to steps S104 to S114. This description may be applied to the method for producing the second structural body 172 of the fourth embodiment (except for the pixel electrode 112) by replacing terms as appropriate. The terms to be replaced include:
“first substrate 141” to be replaced with “second substrate 142”;
“reset transistor 13” to be replaced with “amplification transistor 11”;
“structural body 170” to be replaced with “structural body”;
“second structural body 172” to be replaced with “third structural body 173”;
“first through hole 189a” to be replaced with “second through hole”;
“first via 161” to be replaced with “second via 162”; and
“first wiring layers 151” to be replaced with “second wiring layers 152”.

In the fourth embodiment, the first structural body 171 may be formed as described in the second embodiment.

Also in the method for manufacturing the imaging device 401 according to the fourth embodiment, modifications similar to those in the first to third embodiments are possible.

As is clear from the above description, the manufacturing method according to the present embodiment includes a second joining step, a second hole-forming step, and a second via-forming step performed in that order. In the second joining step, the structural body including the second substrate 142 is joined to the third structural body 173. In the second hole-forming step, a second through hole is formed in the second substrate 142. In the second via-forming step, the second through hole is filled with a second conductor to form the second via 162.

### Fifth Embodiment

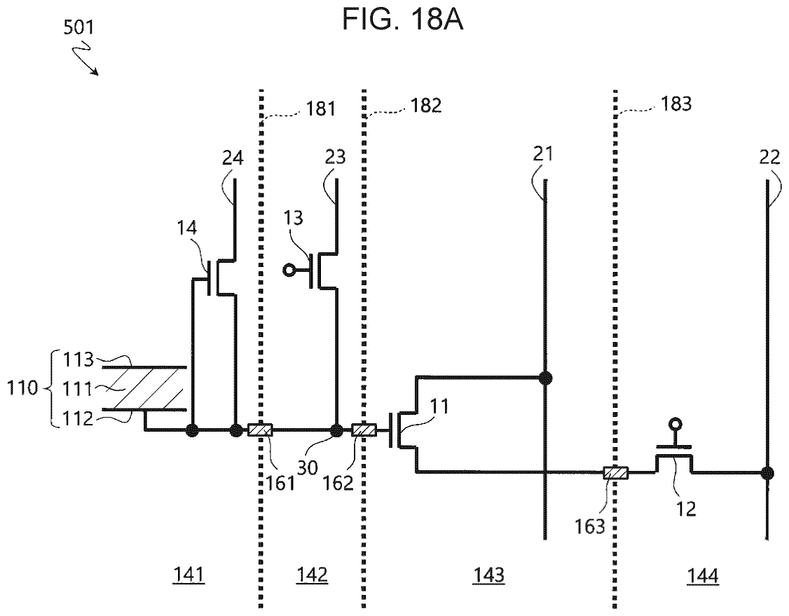

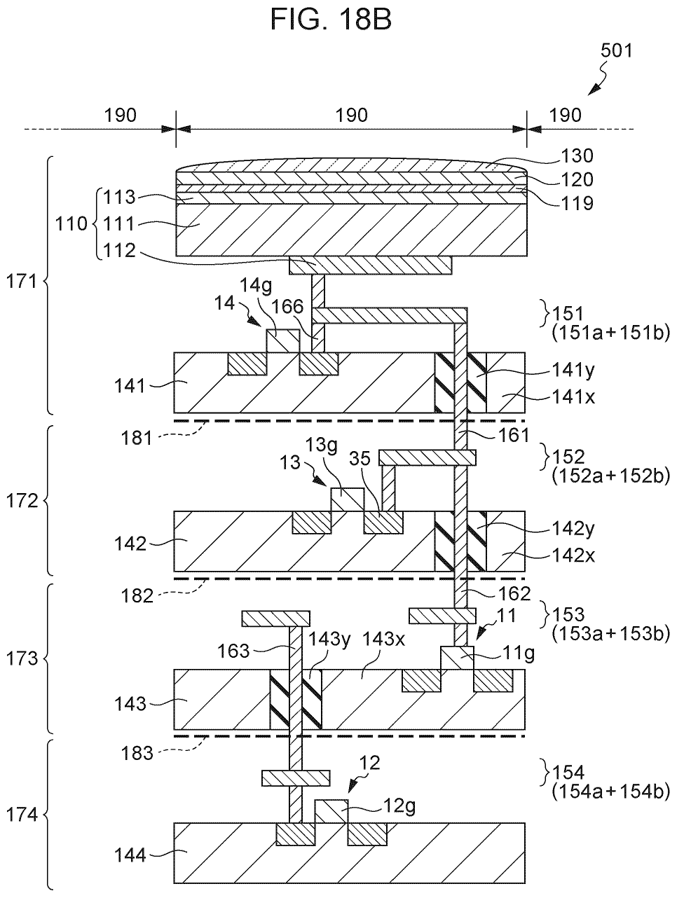

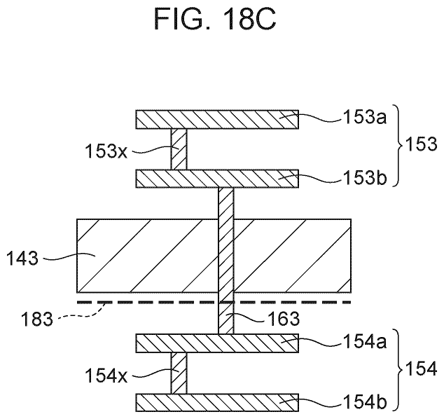

FIGS. 18A and 18B are a circuit diagram and a sectional view, respectively, of an imaging device 501 according to a fifth embodiment. The imaging device 501 includes a fourth substrate 144, fourth wiring layers 154, and a third via 163. These elements are included in a pixel 190 of the imaging device 501. In a typical example, these elements are included in each of multiple pixels 190 of the imaging device 501.

An overflow transistor 14 is provided on a first substrate 141. A reset transistor 13 is provided on a second substrate 142. An amplification transistor 11 is provided on a third substrate 143. A selection transistor 12 is provided on a fourth substrate 144. A microlens 130, a color filter 120, a protective film 119, a photoelectric converter 110, first wiring layers 151, the first substrate 141, second wiring layers 152, the second substrate 142, third wiring layers 153, the third substrate 143, the fourth wiring layers 154, and the fourth substrate 144 are arranged in that order. The fourth wiring layers 154 are disposed closer to a light incident side than the fourth substrate 144.

FIG. 18C is a sectional view of a structure including the third substrate 143. The fourth wiring layers 154 include a wiring layer 154a and a wiring layer 154b. The third substrate 143, the wiring layer 154a, the wiring layer 154b, and the fourth substrate 144 are arranged in that order.

The fourth wiring layers 154 are electrically connected to each other. The fourth wiring layers 154 are conductors and include, for example, a metal. In the illustrated example, the wiring layer 154a and the wiring layer 154b are electrically connected by a via 154x. The third via 163 extends through the third substrate 143 and electrically connects a wiring layer 153b and the wiring layer 154a. The third via 163 is a conductor and includes, for example, a metal. The third wiring layers 153, the fourth wiring layers 154, and the third via 163 are electrically connected to a charge storage region 35.

The imaging device 501 includes a fourth structural body 174. The fourth structural body 174 includes the fourth wiring layers 154 and the fourth substrate 144. A third structural body 173 and the fourth structural body 174 are joined to each other at a third joining interface 183.

As described below, when the imaging device 501 is manufactured, a structural body including the third substrate 143 is formed, and is bonded to the fourth structural body 174. Specifically, the third joining interface 183 is a joining interface formed in this bonding process. After the bonding process, the third via 163 is formed.

The wiring layer 153b and the wiring layer 154a form a third pair of wiring layers 153b and 154a. The third via 163 directly connects the third pair of wiring layers 153b and 154a. The third pair of wiring layers 153b and 154a is connected by the third via 163 without using a Cu—Cu bond. This structure is suitable for providing a small, low-noise imaging device 501. More generally, the third pair of wiring layers 153b and 154a is connected by the third via 163 without using a pair of conductor pads.

The imaging device 501 includes one or more pixels 190. Each of the one or more pixels 190 includes a first structural body 171, a second structural body 172, the third structural body 173, the fourth structural body 174, a first via 161, a second via 162, the third via 163, and the charge storage region 35.

In plan view, the first structural body 171, the second structural body 172, the third structural body 173, the fourth structural body 174, the first via 161, the second via 162, the third via 163, and the charge storage region 35 may be disposed at positions that overlap at least one of the microlens 130 and the color filter 120.

In the present embodiment, the wiring layer 153b is one of the third wiring layers 153 that is closest to the third substrate 143 in the third structural body 173. The wiring layer 153b may be the only wiring layer in the third structural body 173.

In the present embodiment, the wiring layer 154a is one of the fourth wiring layers 154 that is closest to the third substrate 143 in the fourth structural body 174. The wiring layer 154a may be the only wiring layer in the fourth structural body 174.

The first substrate 141 may include a first semiconductor layer 141x and a first oxide film 141y. The first via 161 may extend through the first oxide film 141y. More specifically, the first oxide film 141y may be an embedded oxide film. The first oxide film 141y may be embedded in the first substrate 141 to separate semiconductor devices in the first substrate 141. In one example, the first oxide film 141y extends through the first substrate 141. However, it is not necessary that the first oxide film 141y extend through the first substrate 141.

The second substrate 142 may include a second semiconductor layer 142x and a second oxide film 142y. The second via 162 may extend through the second oxide film 142y. More specifically, the second oxide film 142y may be an embedded oxide film. The second oxide film 142y may be embedded in the second substrate 142 to separate semiconductor devices in the second substrate 142. In one example, the second oxide film 142y extends through the second substrate 142. However, it is not necessary that the second oxide film 142y extend through the second substrate 142.

The third substrate 143 may include a third semiconductor layer 143x and a third oxide film 143y. The third via 163 may extend through the third oxide film 143y. More specifically, the third oxide film 143y may be an embedded oxide film. The third oxide film 143y may be embedded in the third substrate 143 to separate semiconductor devices in the third substrate 143. In one example, the third oxide film 143y extends through the third substrate 143. However, it is not necessary that the third oxide film 143y extend through the third substrate 143.

The first semiconductor layer 141x, the second semiconductor layer 142x, and the third semiconductor layer 143x may include silicon. The first oxide film 141y, the second oxide film 142y, and the third oxide film 143y may be insulating films. The first oxide film 141y, the second oxide film 142y, and the third oxide film 143y may include silicon oxide.

As is clear from the above description, a first transistor is provided on the first substrate 141. A second transistor is provided on the second substrate 142. A third transistor is provided on the third substrate 143. A fourth transistor is provided on the fourth substrate 144. More specifically, each of the one or more pixels 190 includes the first transistor, the second transistor, the third transistor, and the fourth transistor. The structure in which the transistors are separately provided on four substrates is advantageous in terms of increasing the size of individual transistors.

In the illustrated example, the first transistor is the overflow transistor 14. The second transistor is the reset transistor 13. The third transistor is the amplification transistor 11. The fourth transistor is the selection transistor 12.

In the present embodiment, the gate of the first transistor is disposed between the photoelectric converter 110 and the first substrate 141 in the thickness direction of the first substrate 141. The gate of the second transistor is disposed between the photoelectric converter 110 and the second substrate 142 in the thickness direction of the second substrate 142. The gate of the third transistor is disposed between the photoelectric converter 110 and the third substrate 143 in the thickness direction of the third substrate 143. The gate of the fourth transistor is disposed between the photoelectric converter 110 and the fourth substrate 144 in the thickness direction of the fourth substrate 144.

In the present embodiment, the overflow transistor 14 is provided on the first substrate 141. The reset transistor 13 is provided on the second substrate 142. The amplification transistor 11 is provided on the third substrate 143. The selection transistor 12 is provided on the fourth substrate 144. This structure is advantageous in terms of reducing the number of vias that extend through the substrates of the imaging device 501.

According to the studies by the present inventors, similarly to the first to fourth embodiments, also in the fifth embodiment, the arrangement of the transistors may be devised to reduce the number of vias that extend through the substrates to connect the transistors. Tables 4A to 4D show the results of the studies. Tables 4A to 4D show the relationship between the substrates on which the various transistors are disposed and the number of vias. More specifically, in Tables 4A to 4D,
“Fourth Layer” represents the transistors provided on the fourth substrate 144.
“Number of Vias” between “Third Layer” and “Fourth Layer” represents the number of vias extending through the third substrate 143.

TABLE 4A

| | Transistor Arrangement | | | | | |
|---|---|---|---|---|---|---|
| | (1) | (2) | (3) | (4) | (5) | (6) |
| First Layer | OF | OF | OF | OF | OF | OF |
| Number of Vias | 1 | 1 | 1 | 1 | 1 | 1 |
| Second Layer | RX | RX | SF | SF | SEL | SEL |
| Number of Vias | 1 | 1 | 2 | 2 | 2 | 2 |
| Third Layer | SF | SEL | RX | SEL | SF | RX |
| Number of Vias | 1 | 2 | 2 | 1 | 1 | 2 |
| Fourth Layer | SEL | SF | SEL | RX | RX | SF |

TABLE 4B

| | Transistor Arrangement | | | | | |
|---|---|---|---|---|---|---|
| | (7) | (8) | (9) | (10) | (11) | (12) |
| First Layer | RX | RX | RX | RX | RX | RX |
| Number of Vias | 1 | 1 | 1 | 1 | 1 | 1 |
| Second Layer | OF | OF | SF | SF | SEL | SEL |
| Number of Vias | 1 | 1 | 2 | 2 | 2 | 2 |
| Third Layer | SF | SEL | OF | SEL | SF | OF |
| Number of Vias | 1 | 2 | 2 | 1 | 1 | 2 |
| Fourth Layer | SEL | SF | SEL | OF | OF | SF |

TABLE 4C

| | Transistor Arrangement | | | | | |
|---|---|---|---|---|---|---|
| | (13) | (14) | (15) | (16) | (17) | (18) |
| First Layer | SF | SF | SF | SF | SF | SF |
| Number of Vias | 2 | 2 | 2 | 2 | 2 | 2 |
| Second Layer | RX | RX | OF | OFF | SEL | SEL |
| Number of Vias | 2 | OF | 2 | 2 | 1 | 1 |
| Third Layer | OF | SEL | RX | SEL | OF | RX |
| Number of Vias | 2 | 1 | 2 | 1 | 1 | 1 |
| Fourth Layer | SEL | OF | SEL | RX | RX | OF |

TABLE 4D

| | Transistor Arrangement | | | | | |
|---|---|---|---|---|---|---|
| | (19) | (20) | (21) | (22) | (23) | (24) |
| First Layer | SEL | SEL | SEL | SEL | SEL | SEL |
| Number of Vias | 2 | 2 | 2 | 2 | 2 | 2 |
| Second Layer | RX | RX | OF | OFF | SF | SF |
| Number of Vias | 2 | OF | 2 | 2 | 1 | 1 |
| Third Layer | OF | SF | RX | SF | OF | RX |
| Number of Vias | 2 | 1 | 2 | 1 | 1 | 1 |
| Fourth Layer | SF | OF | SF | RX | RX | OF |

As is clear from FIG. 18B, the fifth embodiment corresponds to transistor arrangement (1) in Table 4A.

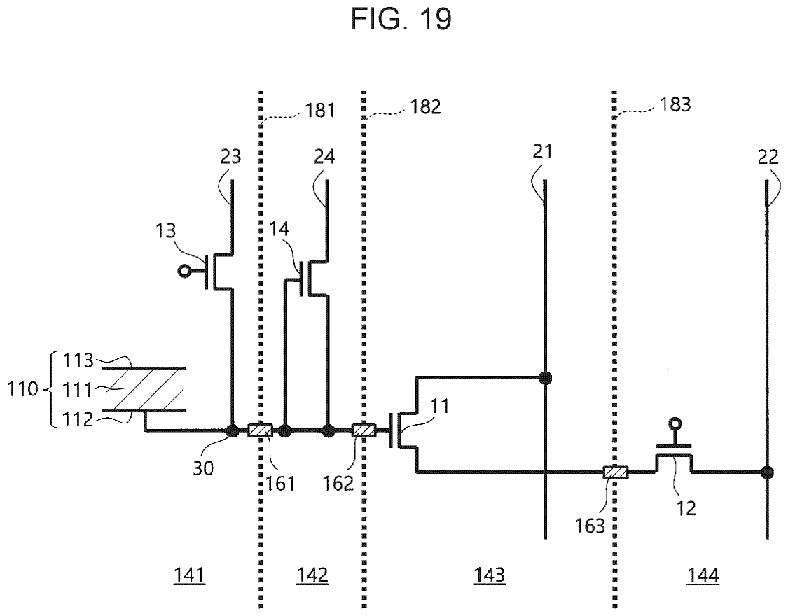

FIG. 19 is a circuit diagram of an imaging device having transistor arrangement (7) in Table 4B. In the example illustrated in FIG. 19, the reset transistor 13 is provided on the first substrate 141. The overflow transistor 14 is provided on the second substrate 142. The amplification transistor 11 is provided on the third substrate 143. The selection transistor 12 is provided on the fourth substrate 144.

The electrical circuits illustrated in FIG. 18A and FIG. 19 are electrically equivalent.

Various modifications are possible in the imaging device 501. The number of wiring layers included in the fourth wiring layers 154 is not particularly limited, and may be two as illustrated, three, or four or more. The third oxide film 143y may be omitted.

In the first embodiment, the method for producing the second structural body 172 is described with reference to steps S101 to S103. This description may be applied to the method for producing the fourth structural body 174 of the fifth embodiment by replacing terms as appropriate. The terms to be replaced include:
“second substrate 142” to be replaced with “fourth substrate 144”;
“amplification transistor 11 and selection transistor 12” to be replaced with “selection transistor 12”; and
“second wiring layers 152” to be replaced with “fourth wiring layers 154”.

In the first embodiment, the method for producing a portion of the first structural body 171 including the structural body 170 and the conductive structure 176 is described with reference to steps S104 to S114. This description may be applied to the method for producing the third structural body 173 of the fifth embodiment (except for the pixel electrode 112) by replacing terms as appropriate. The terms to be replaced include:
“first substrate 141” to be replaced with “third substrate 143”;
“reset transistor 13” to be replaced with “amplification transistor 11”;
“structural body 170” to be replaced with “structural body”;
“second structural body 172” to be replaced with “fourth structural body 174”;
“first through hole 189a” to be replaced with “third through hole”;
“first via 161” to be replaced with “third via 163”; and
“first wiring layers 151” to be replaced with “third wiring layers 153”.

In the first embodiment, the method for producing a portion of the first structural body 171 including the structural body 170 and the conductive structure 176 is described with reference to steps S104 to S114. This description may be applied to the method for producing the second structural body 172 of the fifth embodiment (except for the pixel electrode 112) by replacing terms as appropriate. The terms to be replaced include:
“first substrate 141” to be replaced with “second substrate 142”;
“structural body 170” to be replaced with “structural body”;
“second structural body 172” to be replaced with “third structural body 173”;
“first through hole 189a” to be replaced with “second through hole”;
“first via 161” to be replaced with “second via 162”; and
“first wiring layers 151” to be replaced with “second wiring layers 152”.

The description regarding the production of the first structural body 171 with reference to step S105 in the first embodiment may be applied to the fifth embodiment by replacing terms as appropriate. The terms to be replaced include:
“reset transistor 13” to be replaced with “overflow transistor 14”.

Also in the method for manufacturing the imaging device 501 according to the fifth embodiment, modifications similar to those in the first to fourth embodiments are possible.

As is clear from the above description, the manufacturing method according to the present embodiment includes a third joining step, a third hole-forming step, and a third via-forming step performed in that order. In the third joining step, the structural body including the third substrate 143 is joined to the fourth structural body 174. In the third hole-forming step, a third through hole is formed in the third substrate 143. In the third via-forming step, the third through hole is filled with a third conductor to form the third via 163.

The technique described below is derived from the fourth embodiment and the fifth embodiment. That is, a method for manufacturing an imaging device includes a repeating step and a film-forming step. In the repeating step, a group of steps is repeated, the group of steps including a height-increasing step, a hole-forming step, and a via-forming step performed in that order. In the height-increasing step, a substrate is stacked on a pre-formed structure to increase the height of the structure. In the hole-forming step, a through hole is formed in the substrate. In the via-forming step, a via is formed in the through hole. In the film-forming step, a photoelectric conversion film is formed above the structure. The number of repetitions of the group of steps may be two, three, four, or five or more. Typically, the film-forming step is performed after the repeating step.

### Sixth Embodiment

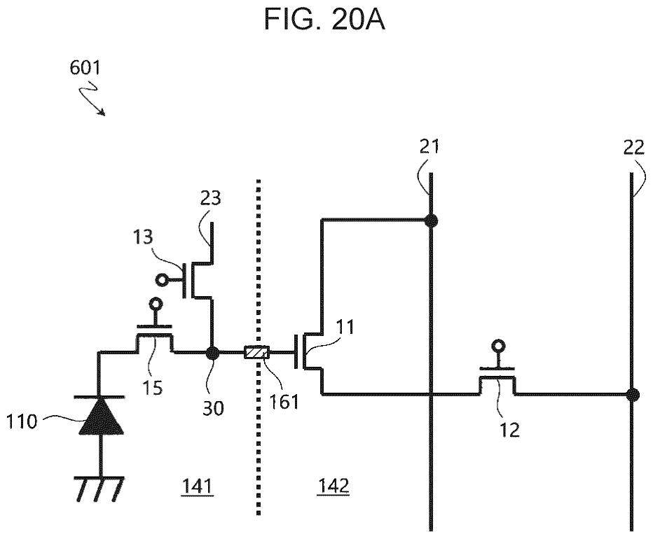

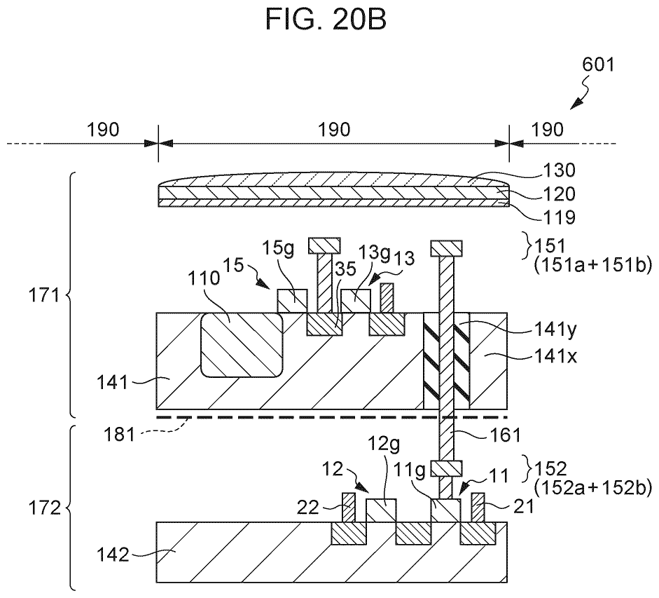

FIGS. 20A and 20B are a circuit diagram and a sectional view, respectively, of an imaging device 601 according to a sixth embodiment. In the imaging device 601, a photoelectric converter 110 is a photodiode. The photoelectric converter 110 is provided on a first substrate 141. The imaging device 601 also includes a transfer transistor 15. The transfer transistor 15 is provided on the first substrate 141. The photoelectric converter 110 and the transfer transistor 15 are included in a pixel 190 of the imaging device 601. In a typical example, the photoelectric converter 110 and the transfer transistor 15 are included in each of multiple pixels 190 of the imaging device 601.

The photoelectric converter 110 is electrically connected to one of a source and a drain of the transfer transistor 15. The other of the source and the drain of the transfer transistor 15, one of a source and a drain of a reset transistor 13, and a gate 11g of an amplification transistor 11 are electrically connected. The one of the source and the drain of the reset transistor 13 forms a charge storage region 35. The other of the source and the drain of the transfer transistor 15 also forms the charge storage region 35. In other words, the charge storage region 35 is shared by the reset transistor 13 and the transfer transistor 15. A first via 161 is electrically connected to the charge storage region 35.

In the present embodiment, a gate 13g of the reset transistor 13 and a gate 15g of the transfer transistor 15 are disposed between a microlens 130 and the first substrate 141 in the thickness direction of the first substrate 141. The gate 11g of the amplification transistor 11 and a gate 12g of a selection transistor 12 are disposed between the microlens 130 and a second substrate 142 in the thickness direction of the second substrate 142.

The photoelectric converter 110 converts light into electric charge. The transfer transistor 15 transfers the electric charge from the photoelectric converter 110 to the charge storage region 35.

### Comparison Between Manufacturing Method of Sixth Embodiment and Manufacturing Methods of First to Fifth Embodiments

As described above, in the sixth embodiment, the photoelectric converter 110 is a photodiode. In the sixth embodiment, step S105 is changed so that the transfer transistor 15 and the photodiode are formed on the first substrate 141 together with the reset transistor 13. Thus, the photodiode is formed, and then the joining process in step S109 is performed. Then, the first via 161, the first wiring layers 151, and other elements are formed in steps S111 to S114.

In contrast, in the first to fifth embodiments, the photoelectric converter 110 includes the photoelectric conversion film 111. In the method for manufacturing the imaging device in which the photoelectric converter 110 includes the photoelectric conversion film 111, the transistors are formed on the first substrate 141 in step S105, and then the joining process in step S109 is performed. Then, the first via 161, the first wiring layers 151, and other elements are formed in steps S111 to S114, and then the photoelectric converter 110 is formed. According to the first to fifth embodiments, compared to the sixth embodiment, the photoelectric converter 110 can be formed later, and therefore the degradation of the photoelectric converter 110 that occurs when the imaging device is manufactured can be reduced. This is advantageous in terms of providing a high-reliability imaging device. When the photoelectric conversion film 111 includes an organic material, the photoelectric conversion film 111 is easily damaged during manufacturing of the imaging device. Therefore, the above-described degradation-reducing effect is particularly advantageous when the photoelectric conversion film 111 includes an organic material.

### Camera System

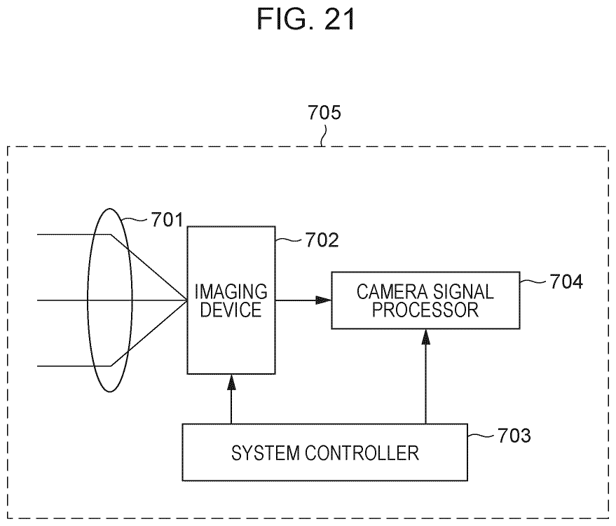

A camera system 705 according to the present embodiment will be described with reference to FIG. 21.

FIG. 21 is a schematic diagram illustrating the structure of the camera system 705 according to the present embodiment. The camera system 705 includes a lens optical system 701, an imaging device 702, a system controller 703, and a camera signal-processing circuit 704. The camera system 705 may be, for example, a smartphone, a digital camera, a video camera, or a vehicle-mounted camera.

The lens optical system 701 may include a lens group, including an autofocus lens and a zoom lens, and a diaphragm. The lens optical system 701 focuses light on an imaging surface of the imaging device 702. The imaging devices according to the above-described first to sixth embodiments may be used as the imaging device 702. The imaging devices described additionally in the first to sixth embodiments may also be used as the imaging device 702.

The system controller 703 controls the overall camera system 705. The system controller 703 is typically a semiconductor integrated circuit, for example, a central processing unit (CPU).

The signal-processing circuit 704 has a function of processing an output signal from the imaging device 702. The signal-processing circuit 704 receives output data from the imaging device 702 and performs, for example, gamma correction, color interpolation, space interpolation, and automatic white balancing. The imaging device 702 and the signal-processing circuit 704 may be formed of a single semiconductor device. The semiconductor device may be, for example, a system on a chip (SoC). This structure enables a further reduction of the size of the electronic device including the imaging device 702. The signal-processing circuit 704 is, for example, a digital signal processor (DSP).

As is clear from the above description, a camera system may include a lens optical system, an imaging device, and a signal-processing circuit. The imaging device receives light that has passed through the lens optical system and outputs a signal. The signal-processing circuit processes the signal.

### APPENDIX

The present disclosure discloses techniques described below.

### Technique 1

An imaging device including:
at least one pixel, each of the at least one pixel including:
   a first structural body including a photoelectric converter that converts light into electric charge, a first one of a first pair of wiring layers, and a first substrate;
   a second structural body including a second one of the first pair of wiring layers and a second substrate;
   a first via that extends through the first substrate and directly connects the first pair of wiring layers; and
   a charge storage region provided on one of substrates including the first substrate and the second substrate, the charge storage region storing the electric charge and being electrically connected to the first via,
wherein the first one of the first pair of wiring layers, the first substrate, the second one of the first pair of wiring layers, and the second substrate are arranged in that order.

Technique 1 is suitable for providing a small, low-noise imaging device. The expression “each of the at least one pixel” refers to each of multiple pixels when multiple pixels are provided. When only one pixel is provided, the above expression refers to that one pixel.

### Technique 2

The imaging device according to technique 1,
wherein the first one of the first pair of wiring layers is included in a wiring layer closest to the first substrate in the first structural body, and
wherein the second one of the first pair of wiring layers is included in a wiring layer closest to the first substrate in the second structural body.

Technique 2 is advantageous in terms of reducing the parasitic capacitance of a charge storage node including the charge storage region.

### Technique 3

The imaging device according to technique 1 or 2,
wherein the first substrate includes a first embedded oxide film, and
wherein the first via extends through the first embedded oxide film.

Technique 3 is advantageous in terms of reducing the parasitic capacitance of a charge storage node including the charge storage region.

### Technique 4

The imaging device according to any one of techniques 1 to 3,
wherein each of the at least one pixel includes:
   a first transistor provided on the first substrate; and
   a second transistor provided on the second substrate.

Technique 4 is advantageous in terms of achieving at least one of an increase in the size of the transistors and a reduction in the size of the imaging device.

### Technique 5

The imaging device according to technique 4,
wherein one of the first transistor and the second transistor is an amplification transistor that outputs a signal corresponding to a potential of the charge storage region.

Technique 5 is advantageous in terms of providing a high-performance imaging device.

### Technique 6

The imaging device according to technique 5,
wherein another of the first transistor and the second transistor is a reset transistor that resets the electric charge stored in the charge storage region.

Technique 6 is advantageous in terms of providing a high-performance imaging device.

### Technique 7

The imaging device according to any one of techniques 1 to 6,
wherein each of the at least one pixel includes:
   an amplification transistor that outputs a signal corresponding to a potential of the charge storage region;
   a reset transistor that resets the electric charge stored in the charge storage region; and
   a selection transistor that determines timing at which the signal is output from the amplification transistor, and
wherein
(a1) the reset transistor is provided on the first substrate, the amplification transistor is provided on the second substrate, and the selection transistor is provided on the second substrate, or
(a2) the amplification transistor is provided on the first substrate, the selection transistor is provided on the first substrate, and the reset transistor is provided on the second substrate.

Technique 7 is advantageous in terms of reducing the number of vias that extend through the substrates in the imaging device.

### Technique 8

The imaging device according to any one of techniques 1 to 7,
wherein each of the at least one pixel includes:
   an amplification transistor that outputs a signal corresponding to a potential of the charge storage region;
   a reset transistor that resets the electric charge stored in the charge storage region; and
   an overflow transistor that includes a gate electrically connected to the charge storage region and that turns on depending on the potential of the charge storage region to discharge the electric charge from the charge storage region, and
wherein
(A1) the overflow transistor is provided on the first substrate, the reset transistor is provided on the first substrate, and the amplification transistor is provided on the second substrate, or
(A2) the amplification transistor is provided on the first substrate, the overflow transistor is provided on the second substrate, and the reset transistor is provided on the second substrate.

Technique 8 is advantageous in terms of reducing the number of vias that extend through the substrates in the imaging device.

### Technique 9

The imaging device according to any one of techniques 1 to 8,
wherein each of the at least one pixel includes:
   a third structural body; and
   a second via,
wherein the second structural body includes a first one of a second pair of wiring layers,
wherein the third structural body includes a second one of the second pair of wiring layers and a third substrate included in the substrates,
wherein the second via extends through the second substrate and directly connects the second pair of wiring layers, and
wherein the first one of the second pair of wiring layers, the second substrate, the second one of the second pair of wiring layers, and the third substrate are arranged in that order.

Technique 9 is suitable for providing a small, low-noise imaging device. In technique 1 and technique 9, the second one of the first pair of wiring layers and the first one of the second pair of wiring layers may be the same or different.

### Technique 10

The imaging device according to technique 9,
wherein each of the at least one pixel includes:
   a first transistor provided on the first substrate;
   a second transistor provided on the second substrate; and
   a third transistor provided on the third substrate.

Technique 10 is advantageous in terms of achieving at least one of an increase in the size of the transistors and a reduction in the size of the imaging device.

### Technique 11

The imaging device according to technique 9 or 10,
wherein each of the at least one pixel includes:
   an amplification transistor that outputs a signal corresponding to a potential of the charge storage region;
   a reset transistor that resets the electric charge stored in the charge storage region; and
   a selection transistor that determines timing at which the signal is output from the amplification transistor, and
wherein
(d1) the reset transistor is provided on the first substrate, the amplification transistor is provided on the second substrate, and the selection transistor is provided on the third substrate,
(d2) the amplification transistor is provided on the first substrate, the selection transistor is provided on the first substrate, and the reset transistor is provided on the third substrate,
(d3) the amplification transistor is provided on the first substrate, the selection transistor is provided on the first substrate, and the reset transistor is provided on the second substrate,
(d4) the amplification transistor is provided on the second substrate, the selection transistor is provided on the second substrate, and the reset transistor is provided on the third substrate,
(d5) the reset transistor is provided on the first substrate, the amplification transistor is provided on the second substrate, and the selection transistor is provided on the second substrate,
(d6) the reset transistor is provided on the second substrate, the amplification transistor is provided on the third substrate, and the selection transistor is provided on the third substrate, or
(d7) the reset transistor is provided on the first substrate, the amplification transistor is provided on the third substrate, and the selection transistor is provided on the third substrate.

Technique 11 is advantageous in terms of reducing the number of vias that extend through the substrates in the imaging device.

### Technique 12

The imaging device according to any one of techniques 9 to 11,
wherein each of the at least one pixel includes:
   an amplification transistor that outputs a signal corresponding to a potential of the charge storage region;
   a reset transistor that resets the electric charge stored in the charge storage region; and
   an overflow transistor that includes a gate electrically connected to the charge storage region and that turns on depending on the potential of the charge storage region to discharge the electric charge from the charge storage region, and
wherein
(D1) the reset transistor is provided on the first substrate, the overflow transistor is provided on the first substrate, and the amplification transistor is provided on the second substrate,
(D2) the amplification transistor is provided on the first substrate, the overflow transistor is provided on the second substrate, and the reset transistor is provided on the third substrate,
(D3) the amplification transistor is provided on the first substrate, the reset transistor is provided on the second substrate, and the overflow transistor is provided on the third substrate,
(D4) the reset transistor is provided on the first substrate, the overflow transistor is provided on the second substrate, and the amplification transistor is provided on the second substrate,
(D5) the overflow transistor is provided on the first substrate, the amplification transistor is provided on the second substrate, and the reset transistor is provided on the third substrate,
(D6) the reset transistor is provided on the first substrate, the amplification transistor is provided on the second substrate, and the overflow transistor is provided on the third substrate,
(D7) the overflow transistor is provided on the first substrate, the reset transistor is provided on the second substrate, and the amplification transistor is provided on the third substrate, or
(D8) the reset transistor is provided on the first substrate, the overflow transistor is provided on the second substrate, and the amplification transistor is provided on the third substrate.

Technique 12 is advantageous in terms of reducing the number of vias that extend through the substrates in the imaging device.

### Technique 13

The imaging device according to any one of techniques 9 to 12,
wherein each of the at least one pixel includes:
   a fourth structural body; and
   a third via,
wherein the third structural body includes a first one of a third pair of wiring layers,
wherein the fourth structural body includes a second one of the third pair of wiring layers and a fourth substrate included in the substrates,
wherein the third via extends through the third substrate and directly connects the third pair of wiring layers, and
wherein the first one of the third pair of wiring layers, the third substrate, the second one of the third pair of wiring layers, and the fourth substrate are arranged in that order.

Technique 13 is suitable for providing a small, low-noise imaging device. In technique 9 and technique 13, the second one of the second pair of wiring layers and the first one of the third pair of wiring layers may be the same or different.

### Technique 14

The imaging device according to technique 13,
wherein each of the at least one pixel includes:
   a first transistor provided on the first substrate;
   a second transistor provided on the second substrate;
   a third transistor provided on the third substrate; and
   a fourth transistor provided on the fourth substrate.

Technique 14 is advantageous in terms of achieving at least one of an increase in the size of the transistors and a reduction in the size of the imaging device.

### Technique 15

The imaging device according to technique 13 or 14,
wherein each of the at least one pixel includes:
   an amplification transistor that outputs a signal corresponding to a potential of the charge storage region;
   a reset transistor that resets the electric charge stored in the charge storage region;
   a selection transistor that determines timing at which the signal is output from the amplification transistor; and
   an overflow transistor that includes a gate electrically connected to the charge storage region and that turns on depending on the potential of the charge storage region to discharge the electric charge from the charge storage region, and
wherein
(f1) the overflow transistor is provided on the first substrate, the reset transistor is provided on the second substrate, the amplification transistor is provided on the third substrate, and the selection transistor is provided on the fourth substrate, or
(f2) the reset transistor is provided on the first substrate, the overflow transistor is provided on the second substrate, the amplification transistor is provided on the third substrate, and the selection transistor is provided on the fourth substrate.

Technique 15 is advantageous in terms of reducing the number of vias that extend through the substrates in the imaging device.

### Technique 16

The imaging device according to any one of techniques 1 to 15,
wherein each of the at least one pixel includes a transistor provided on the second substrate,
wherein the transistor includes a gate, and
wherein the gate is disposed between the photoelectric converter and the second substrate in a thickness direction of the second substrate.

Technique 16 is advantageous in terms of providing a low-noise first transistor.

### Technique 17

The imaging device according to any one of techniques 1 to 16,
wherein the photoelectric converter includes a photoelectric conversion film.

The structure of technique 17 is an example.

### Technique 18

The imaging device according to technique 17,
wherein the photoelectric conversion film includes an organic material.

The structure of technique 18 is an example.

### Technique 19

An imaging device including:
a first structural body including a photoelectric converter that converts light into electric charge, a first one of a first pair of wiring layers, and a first substrate;
a second structural body including a second one of the first pair of wiring layers and a second substrate;
a first via that extends through the first substrate; and
a charge storage region provided on one of substrates including the first substrate and the second substrate, the charge storage region storing the electric charge and being electrically connected to the first via,
wherein the first one of the first pair of wiring layers, the first substrate, the second one of the first pair of wiring layers, and the second substrate are arranged in that order, and
wherein the first pair of wiring layers is connected by the first via without using a Cu—Cu bond.

Technique 19 is suitable for providing a small, low-noise imaging device.

### Technique 20

A camera system including:
a lens optical system;
the imaging device according to any one of techniques 1 to 19 that receives light that has passed through the lens optical system and outputs a signal; and
a signal-processing circuit that processes the signal.

Technique 20 is suitable for providing a small, low-noise imaging device.

### Technique 21

A method for manufacturing an imaging device,
wherein the imaging device includes:
   a first structural body including a photoelectric conversion film that converts light into electric charge, a first one of a first pair of wiring layers, and a first substrate;
   a second structural body including a second one of the first pair of wiring layers and a second substrate;
   a first via that extends through the first substrate and directly connects the first pair of wiring layers; and
   a charge storage region provided on one of substrates including the first substrate and the second substrate, the charge storage region storing the electric charge and being electrically connected to the first via,
wherein the method includes:
   joining a structural body including the first substrate to the second structural body;
   forming a first through hole in the first substrate;
   forming the first via by filling the first through hole with a first conductor; and
   forming the photoelectric conversion film, and
wherein the joining of the structural body to the second structural body, the forming of the first through hole, the forming of the first via, and the forming of the photoelectric conversion film are performed in that order.

Technique 21 is suitable for providing a small, low-noise imaging device.

### Technique 22

The method according to technique 21,
wherein the imaging device includes:
   a third structural body; and
   a second via,
wherein the second structural body includes a first one of a second pair of wiring layers,
wherein the third structural body includes a second one of the second pair of wiring layers and a third substrate included in the substrates,
wherein the second via extends through the second substrate and directly connects the second pair of wiring layers, and
wherein the method includes:
   joining a structural body including the second substrate to the third structural body;
   forming a second through hole in the second substrate; and
   forming the second via by filling the second through hole with a second conductor, and
wherein the joining of the structural body to the third structural body, the forming of the second through hole, and the forming of the second via are performed in that order.

Technique 22 is suitable for providing a small, low-noise imaging device.

### Technique 23

The method according to technique 22,
wherein the imaging device includes:
   a fourth structural body; and
   a third via,
wherein the third structural body includes a first one of a third pair of wiring layers,
wherein the fourth structural body includes a second one of the third pair of wiring layers and a fourth substrate included in the substrates,
wherein the third via extends through the third substrate and directly connects the third pair of wiring layers, and
wherein the method includes:
   joining a structural body including the third substrate to the fourth structural body;
   forming a third through hole in the third substrate; and
   forming the third via by filling the third through hole with a third conductor, and
wherein the joining of the structural body to the fourth structural body, the forming of the third through hole, and the forming of the third via are performed in that order.

Technique 23 is suitable for providing a small, low-noise imaging device.

### Technique 24

A method for manufacturing an imaging device, the method including:
repeating processes of stacking a substrate on a pre-formed structure to increase a height of the structure, forming a through hole in the substrate, and forming a via in the through hole in that order; and
forming a photoelectric conversion film above the structure.

Technique 24 is suitable for providing a small, low-noise imaging device.

### OTHERS

The first one of the first pair of wiring layers is an example of a first wiring line. The second one of the first pair of wiring layers is an example of a second wiring line. The first one of the second pair of wiring layers is an example of a third wiring line. The second one of the second pair of wiring layers is an example of a fourth wiring line. The first one of the third pair of wiring layers is an example of a fifth wiring line. The second one of the third pair of wiring layers is an example of a sixth wiring line.

The imaging device according to the present disclosure is suitable for use in, for example, a digital camera. The imaging device according to the present disclosure may be used in, for example, a mobile terminal.

What is claimed is:

1. An imaging device comprising:
at least one pixel, each of the at least one pixel including:
a first structural body including a photoelectric converter that converts light into electric charge, a first wiring line, and a first substrate;
a second structural body including a second wiring line and a second substrate;
a first via that extends through the first substrate and directly connects the first wiring line and the second wiring line; and
a charge storage region provided on one of substrates including the first substrate and the second substrate, the charge storage region storing the electric charge and being electrically connected to the first via,
wherein the photoelectric converter, the first wiring line, the first substrate, the second wiring line, and the second substrate are arranged in that order.

2. The imaging device according to claim 1,
wherein the first wiring line is included in a wiring layer closest to the first substrate in the first structural body, and
wherein the second wiring line is included in a wiring layer closest to the first substrate in the second structural body.

3. The imaging device according to claim 1,
wherein the first substrate includes a first embedded oxide film, and
wherein the first via extends through the first embedded oxide film.

4. The imaging device according to claim 1,
wherein each of the at least one pixel includes:
a first transistor provided on the first substrate; and
a second transistor provided on the second substrate.

5. The imaging device according to claim 4,
wherein one of the first transistor and the second transistor is an amplification transistor that outputs a signal corresponding to a potential of the charge storage region.

6. The imaging device according to claim 5,
wherein another of the first transistor and the second transistor is a reset transistor that resets the electric charge stored in the charge storage region.

7. The imaging device according to claim 1,
wherein each of the at least one pixel includes:
an amplification transistor that outputs a signal corresponding to a potential of the charge storage region;
a reset transistor that resets the electric charge stored in the charge storage region; and
a selection transistor that determines timing at which the signal is output from the amplification transistor, and
wherein
(a1) the reset transistor is provided on the first substrate, the amplification transistor is provided on the second substrate, and the selection transistor is provided on the second substrate, or
(a2) the amplification transistor is provided on the first substrate, the selection transistor is provided on the first substrate, and the reset transistor is provided on the second substrate.

8. The imaging device according to claim 1,
wherein each of the at least one pixel includes:
an amplification transistor that outputs a signal corresponding to a potential of the charge storage region;
a reset transistor that resets the electric charge stored in the charge storage region; and
an overflow transistor that includes a gate electrically connected to the charge storage region and that turns on depending on the potential of the charge storage region to discharge the electric charge from the charge storage region, and
wherein
(A1) the overflow transistor is provided on the first substrate, the reset transistor is provided on the first substrate, and the amplification transistor is provided on the second substrate, or
(A2) the amplification transistor is provided on the first substrate, the overflow transistor is provided on the second substrate, and the reset transistor is provided on the second substrate.

9. The imaging device according to claim 1,
wherein each of the at least one pixel includes:
a third structural body; and
a second via,
wherein the second structural body includes a third wiring line,
wherein the third structural body includes a fourth wiring line and a third substrate included in the substrates,
wherein the second via extends through the second substrate and directly connects the third wiring line and the fourth wiring line, and
wherein the third wiring line, the second substrate, the fourth wiring line, and the third substrate are arranged in that order.

10. The imaging device according to claim 9,
wherein each of the at least one pixel includes:
a first transistor provided on the first substrate;
a second transistor provided on the second substrate; and
a third transistor provided on the third substrate.

11. The imaging device according to claim 9,
wherein each of the at least one pixel includes:
a reset transistor that is provided on the first substrate and that resets the electric charge stored in the charge storage region;
an amplification transistor that is provided on the second substrate and that outputs a signal corresponding to a potential of the charge storage region; and
a selection transistor that is provided on the third substrate and that determines timing at which the signal is output from the amplification transistor.

12. The imaging device according to claim 9,
wherein each of the at least one pixel includes:
an amplification transistor that outputs a signal corresponding to a potential of the charge storage region;
a reset transistor that resets the electric charge stored in the charge storage region; and
a selection transistor that determines timing at which the signal is output from the amplification transistor, and
wherein
(d1) the reset transistor is provided on the first substrate, the amplification transistor is provided on the second substrate, and the selection transistor is provided on the third substrate,
(d2) the amplification transistor is provided on the first substrate, the selection transistor is provided on the first substrate, and the reset transistor is provided on the third substrate,
(d3) the amplification transistor is provided on the first substrate, the selection transistor is provided on the first substrate, and the reset transistor is provided on the second substrate,
(d4) the amplification transistor is provided on the second substrate, the selection transistor is provided on the second substrate, and the reset transistor is provided on the third substrate,
(d5) the reset transistor is provided on the first substrate, the amplification transistor is provided on the second substrate, and the selection transistor is provided on the second substrate,
(d6) the reset transistor is provided on the second substrate, the amplification transistor is provided on the third substrate, and the selection transistor is provided on the third substrate, or
(d7) the reset transistor is provided on the first substrate, the amplification transistor is provided on the third substrate, and the selection transistor is provided on the third substrate.

13. The imaging device according to claim 9,
wherein each of the at least one pixel includes:
an amplification transistor that outputs a signal corresponding to a potential of the charge storage region;
a reset transistor that resets the electric charge stored in the charge storage region; and
an overflow transistor that includes a gate electrically connected to the charge storage region and that turns on depending on the potential of the charge storage region to discharge the electric charge from the charge storage region, and
wherein
(D1) the reset transistor is provided on the first substrate, the overflow transistor is provided on the first substrate, and the amplification transistor is provided on the second substrate,
(D2) the amplification transistor is provided on the first substrate, the overflow transistor is provided on the second substrate, and the reset transistor is provided on the third substrate,
(D3) the amplification transistor is provided on the first substrate, the reset transistor is provided on the second substrate, and the overflow transistor is provided on the third substrate,
(D4) the reset transistor is provided on the first substrate, the overflow transistor is provided on the second substrate, and the amplification transistor is provided on the second substrate,
(D5) the overflow transistor is provided on the first substrate, the amplification transistor is provided on the second substrate, and the reset transistor is provided on the third substrate,
(D6) the reset transistor is provided on the first substrate, the amplification transistor is provided on the second substrate, and the overflow transistor is provided on the third substrate,
(D7) the overflow transistor is provided on the first substrate, the reset transistor is provided on the second substrate, and the amplification transistor is provided on the third substrate, or
(D8) the reset transistor is provided on the first substrate, the overflow transistor is provided on the second substrate, and the amplification transistor is provided on the third substrate.

14. The imaging device according to claim 9,
wherein each of the at least one pixel includes:
a fourth structural body; and
a third via,
wherein the third structural body includes a fifth wiring line,
wherein the fourth structural body includes a sixth wiring line and a fourth substrate included in the substrates,
wherein the third via extends through the third substrate and directly connects the fifth wiring line and the sixth wiring line, and
wherein the fifth wiring line, the third substrate, the sixth wiring line, and the fourth substrate are arranged in that order.

15. The imaging device according to claim 14,
wherein each of the at least one pixel includes:
a first transistor provided on the first substrate;
a second transistor provided on the second substrate;
a third transistor provided on the third substrate; and
a fourth transistor provided on the fourth substrate.

16. The imaging device according to claim 14,
wherein each of the at least one pixel includes:
an amplification transistor that outputs a signal corresponding to a potential of the charge storage region;
a reset transistor that resets the electric charge stored in the charge storage region;
a selection transistor that determines timing at which the signal is output from the amplification transistor; and
an overflow transistor that includes a gate electrically connected to the charge storage region and that turns on depending on the potential of the charge storage region to discharge the electric charge from the charge storage region, and
wherein
(f1) the overflow transistor is provided on the first substrate, the reset transistor is provided on the second substrate, the amplification transistor is provided on the third substrate, and the selection transistor is provided on the fourth substrate, or
(f2) the reset transistor is provided on the first substrate, the overflow transistor is provided on the second substrate, the amplification transistor is provided on the third substrate, and the selection transistor is provided on the fourth substrate.

17. The imaging device according to claim 1,
wherein each of the at least one pixel includes a transistor provided on the second substrate,
wherein the transistor includes a gate, and
wherein the gate is disposed between the photoelectric converter and the second substrate in a thickness direction of the second substrate.

18. The imaging device according to claim 1,
wherein the photoelectric converter includes a photoelectric conversion film.

19. The imaging device according to claim 18,
wherein the photoelectric conversion film includes an organic material.

20. A method for manufacturing an imaging device, the method comprising:
forming a joined body by joining a first structural body including an insulating layer and a first substrate and a second structural body including a second wiring line and a second substrate such that the insulating layer, the first substrate, the second wiring line, and the second substrate are arranged in that order;
forming a trench in a surface of the joined body on a side at which the insulating layer is provided;
forming a through hole extending from the trench to the second wiring line;
forming a first wiring line and a first via by filling the trench and the through hole with a conductor; and
forming a photoelectric converter.
